(19) United States
(12) Patent Application Publication
(10) Pub. No.: US 2008/0116366 A1
(43) Pub. Date: May 22, 2008

(54) LASER DESORPTION DEVICE, MASS SPECTROMETER ASSEMBLY, AND METHOD FOR AMBIENT LIQUID MASS SPECTROMETRY

(75) Inventors: Jentaie SHIEA, Kaohsiung City (TW); Cheng-Hui Yuan, Taipei-City (TW)

Correspondence Address: FOLEY AND LARDNER LLP;SUITE 500, 3000 K STREET NW, WASHINGTON, DC, 20007, US

(73) Assignee: Jantaie SHIEA

(21) Appl. No.: 11/746,282

(22) Filed: May 9, 2007

Related U.S. Application Data
(63) Continuation-in-part of application No. 11/561,131, filed on Nov. 17, 2006.

(51) Int. Cl. B01D 59/44; H01J 27/02

(52) U.S. Cl. 250/282; 250/288; 250/423 F

(57) ABSTRACT

An electrospray-assisted laser desorption ionization device includes: an electrospray unit including a nozzle; a voltage supplying member disposed to establish between the nozzle and a receiving unit a potential difference such that liquid drops of the electrospray medium formed at the nozzle are laden with charges, and such that the liquid drops are forced to leave the nozzle toward the receiving unit along a traveling path; a laser desorption unit adapted to irradiate a sample such that, upon irradiation, analytes contained in the sample are desorbed to fly along a flying path which intersects the traveling path so as to enable the analytes to be occluded in the liquid drops, and such that as a result of dwindling in size of the liquid drops when moving along the traveling path, charges of the liquid drops will pass on to the analytes occluded therein to form ionized analytes.

### CROSS-REFERENCE TO RELATED APPLICATION

This application is a continuation-in-part (CIP) of U.S. patent application Ser. No. 11/561,131, entitled “ELECTROSPRAY-ASSISTED LASER DESORPTION IONIZATION DEVICE, MASS SPECTROMETER, AND METHOD FOR MASS SPECTROMETRY”, filed on Nov. 17, 2006.

### BACKGROUND OF THE INVENTION

1. Field of the Invention

The invention relates to a method for mass spectrometry, more particularly to a method for ambient liquid mass spectrometry that is capable of conducting direct analysis of mass spectrometry on a liquid sample under atmospheric pressure. In addition, the present invention also relates to a laser desorption device that is adapted for use with a receiving unit, an electrospray unit, and a voltage supplying member in a mass spectrometer so as to conduct ambient liquid mass spectrometry. Further, the present invention relates to a mass spectrometer assembly incorporating the laser desorption device.

2. Description of the Related Art

A method for mass spectrometry is called laser desorption mass spectrometry (LD-MS), where a laser beam is irradiated at the surface of a tissue section such that the protein molecules at the site of impact absorb the energy of the laser beam to thereby directly desorb from the surface of the tissue section in the form of ions carrying electric charges. Mass spectrometric analysis is then performed by a mass analyzer. For relevant techniques, please refer to the following article: Tabet, J. C., Cotter, R. J. Anal. Chem. 1984; 56, 1662. It is widely recognized that among the analytes desorbed by the laser beam, the number of neutral analytes far exceeds the number of ionized analytes; that is, ionization efficiency is extremely low. The signal resulted from this extremely low ratio of ionized analytes is too small and is therefore easily interfered by noise signals. At the same time, detection sensitivity and reconstruction ability of the signals are poor such that results of the mass spectrometric analysis is relatively less reliable, and is therefore hardly determinative.

Another method for mass spectrometry is called electrospray ionization mass spectrometry (ESI-MS), which involves ionizing proteins contained in a liquid sample, followed by a protein analysis. As illustrated in FIG. 1, an electrospray ionization mass spectrometer (ESI-MS) 1 includes an electrospray ionization device 11. For relevant technology, please refer to the following article: Yamashita, M., Fenn, J. B. J. Phys. Chem. 1984; 88, 4451.

The electrospray ionization device 11 of the electrospray ionization mass spectrometer 1 performs an electrospray ionization procedure to ionize the proteins in the liquid sample. The electrospray ionization device 11 includes a capillary 112 having an open end 111 that opens toward an entrance side 121 of a mass analyzer 12 included in the electrospray ionization mass spectrometer 1. When in use, an electric field, for instance, a 2 kV to 5 kV voltage difference, is established between the open end 111 of the capillary 112 and the entrance side 121 of the mass analyzer 12. Subsequently, the liquid sample is pushed through the capillary 112 toward the open end 111. The liquid sample forms a Taylor cone 2 that is filled with electric charges as it passes through the open end 111 of the capillary 112 due to the combined effect of the electric field present between the open end 111 of the capillary 112 and the entrance side 121 of the mass analyzer 12 and the surface tension of the liquid sample at the open end 111. As the electric field force overcomes the surface tension of the liquid sample at the open end 111 of the capillary 112, aerosol droplets containing multivalent electric charges and protein molecules are formed, and are pushed into the mass analyzer 12 through the entrance side 121 thereof.

As the charged droplets travel through the air from the open end 111 of the capillary 112 toward the entrance side 121 of the mass analyzer 12, the liquid portion of the charged droplets vaporize such that the charged droplets dwindle in size, causing the multivalent electrons to attach to the protein molecules to form ionized protein molecules with relatively lower m/z values (i.e., the mass-to-charge ratio, where m is the mass of the ionized molecule, and z is the ionic charge/number of elementary charges). Since the molecular weight of a macromolecule, such as a protein molecule, is in the hundreds of thousands, charges attached to each of the macromolecules for forming the ionized molecules need to be multivalent in order for the m/z value to be low enough so as to be detectable by the mass analyzer 12. Not only does the electrospray ionization method allow macromolecules to be efficiently ionized, but it also overcomes the detection limit imposed by the mass analyzer 12 since a lower m/z value can be obtained. Therefore, protein molecules can be studied using electrospray ionization mass spectrometry.

However, body fluids or other biochemical solutions normally contain a high concentration of various salts. Without “desalination” pre-process such as dialysis, the protein molecules may very likely become ionized by acquiring charges from the salts, such as Na⁺, K⁺, H⁺, that are present in the body fluids/biochemical solutions. Consequently, a complicated ion peak configuration results in the mass spectrum, where some ion peaks are produced by the protein molecules that are ionized through acquiring charges from the salts, making it difficult to determine the identity of these ion peaks. Even with the assistance of a computer software, no accuracy in the molecular weight calculations of the proteins and the determination of the identities of the proteins is promisable.

After dialysis, the liquid samples (body fluids or other biochemical solutions) can be “desalinated” to result in a simpler ion peak configuration in the mass spectrum. However, professional personnel are required to execute the “desalination” pre-process, which is a tedious, time consuming and very inconvenient process.

Other methods for mass spectrometry require converting an originally liquid-state sample into a solid-state sample prior to conducting the analysis. One of these methods is called the matrix-assisted laser desorption ionization mass spectrometry (MALDI-MS). This method has a relatively high sensitivity and a relatively high detection range. For relevant technology, please refer to the following article: Karas, M., Hillenkamp, F. Anal. Chem. 1988; 60, 2299.

When conducting mass spectrometry on a liquid sample containing protein molecules using MALDI-MS, a general way is to mix a water soluble organic acidic matrix of highly laser light absorbing small organic molecules [e.g. small molecules having conjugate double bond or aromatic ring in 2,5-dihydroxybenzoic acid], with the liquid sample. After the mixture is homogenized, it is dehydrated such that the organic acidic matrix is co-crystallized with the protein molecules. Then, a laser beam is irradiated on the surface of the crystal by a laser transmission device, causing ionization and desorption of the protein molecules. Under an electric field, the ionized protein molecules are introduced into amass analyzer for mass spectrometric analysis.

However, the resolution of MALDI-MS is poor, and due to the small amount of protein molecules (analyte) available, the desorption process of MALDI-MS needs to be conducted in vacuum. This not only increases the cost of instrumentation, but is also inconvenient as switching between vacuum/atmospheric pressure environments during replacement of samples requires a number of tedious instrumental operations.

An atmospheric pressure-MALDI (AP-MALDI) that is capable of conducting mass spectrometric analysis under atmospheric pressure has been introduced, but it is also required that the sample be in solid form.

It is noted that the abovedescribed methods for mass spectrometry many times, can prove to successfully identify the types of proteins contained in the samples. However, since under a lot of circumstances, the samples, such as body fluids (e.g., urine, blood), are in liquid form to begin with, it is rather inconvenient and time consuming to transform the liquid samples into solid samples in order to perform mass spectrometric analysis, especially when the number of samples to be analyzed is quite large.

Some liquid materials have been found to be suitable for serving as a matrix used in MALDI, such as glycerin, nitro-benzyl alcohol, etc. It is disclosed in the article, Anal. Chem. 1995; 67: 4335-4342, that a mixture of glycerin and carbon powder serves as the matrix in a special type of MALDI-MS called “surface-assisted laser desorption/ionization” (SALDI) mass spectrometry (SALDI-MS). A liquid sample containing proteins (i.e., the analyte) and the matrix (e.g., the mixture of glycerin and carbon powder) can be analyzed using SALDI-MS if irradiated by an ultraviolet laser having a wavelength of 337 nm. Even though this special type of MALDI-MS method is capable of conducting mass spectrometric analysis on a liquid sample, a vacuum environment is still required. Moreover, a highly viscous solute, such as glycerin, is required for preparing the liquid sample, keeping the cost of instrumentation high and preparation of the sample tedious. In addition, the liquid state matrix can only be used for analyzing samples with molecular weights under 30,000, making application of SALDI-MS limited. Another shortcoming of MALDI-MS is that the matrix used is generally an organic acid, which affects the analyte (e.g., proteins) chemically, causing the structure of the analyte to change.

It can be seen from the above that conducting protein analysis directly on a liquid sample using mass spectrometry techniques presents a variety of difficulties and inconveniences. Since spatial analytic information on proteins of organs or tissues is extremely important in the medical and biotechnological fields, there exists a great need for a method of mass spectrometry that is capable of conducting rapid, convenient, and accurate protein analysis on a liquid sample under atmospheric pressure.

### SUMMARY OF THE INVENTION

Therefore, the object of the present invention is to provide a laser desorption device, amass spectrometer assembly, and a method for mass spectrometry that is capable of conducting mass analysis directly on a liquid sample under atmospheric pressure.

According to one aspect of the present invention, there is provided a method for mass spectrometry, which is named “ambient liquid mass spectrometry”, and which includes the steps of:

placing, on a sample stage, a liquid sample including a solution that contains a plurality of analytes and a material serving as a matrix for absorbing laser energy so as to assist in desorption of at least one of the analytes;

providing an electrospray unit that includes a nozzle configured to sequentially form liquid drops of an electrospray medium thereat;

providing a receiving unit that is disposed to admit therein ionized analytes that are derived from the liquid sample, and that are to be analyzed by a mass analyzer disposed downstream of the receiving unit, the receiving unit being spaced apart from the nozzle of the electrospray unit in a longitudinal direction so as to define a traveling path;

establishing a potential difference between the nozzle of the electrospray unit and the receiving unit, the potential difference being of an intensity such that the liquid drops are laden with a plurality of charges, and such that the liquid drops are forced to leave the nozzle as multiple-charged ones for heading toward the receiving unit along the traveling path; and

irradiating the liquid sample with a laser beam such that, upon irradiation, laser energy is passed on to at least one of the analytes contained in the solution of the liquid sample via the matrix so that said at least one of the analytes contained in the liquid sample is desorbed to fly along a flying path which intersects the traveling path so as to enable said at least one of the analytes to be occluded in the multiple-charged liquid drops, and such that as a result of dwindling in size of the multiple-charged liquid drops when approaching the receiving unit along the traveling path, charges of the liquid drops will pass on to said at least one of the analytes occluded therein to form a corresponding one of the ionized analytes.

According to another aspect of the present invention, there is provided a laser desorption device for use in a mass spectrometer assembly.

The mass spectrometer assembly includes a receiving unit, an electrospray unit, and a voltage supplying member. The laser desorption device includes a sample stage and a laser transmission mechanism. The sample stage and the laser transmission mechanism are arranged with the receiving unit, the electrospray unit, and the voltage supplying member in a manner such that all the steps of the abovementioned method can be duly carried out. The laser transmission mechanism can be one of an ultraviolet (UV) laser, an infrared (IR) laser, a nitrogen laser, an argon ion laser, a helium-neon laser, a carbon dioxide (CO₂) laser, and a garnet (Nd:YAG) laser.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of various components included in an electrospray ionization mass spectrometer (ESI-MS) of the prior art to illustrate relative positions of the components and operational method involved in the ESI-MS;

FIG. 2 is a schematic diagram of a laser desorption device and an electrospray unit for the first preferred embodiment of a mass spectrometer assembly implementing the method of ambient liquid mass spectrometry according to the present invention, illustrating desorption of analytes contained in a liquid sample so as to fly along a flying path that intersects a traveling path of multiple-charged liquid drops;

FIG. 3 is a schematic diagram, illustrating occlusion of the analytes in the multiple-charged liquid drops, and formation of ionized analytes as a result of dwindling in size of the multiple-charged liquid drops having the analytes occluded therein;

FIG. 4 is a schematic side view of the first and fifth preferred embodiments of a mass spectrometer assembly implementing the method of ambient liquid mass spectrometry according to the present invention;

FIG. 5 is a fragmentary enlarged view of the second preferred embodiment of a mass spectrometer assembly implementing the method of ambient liquid mass spectrometry according to the present invention, illustrating relative positions of an airstream supplying mechanism and a nozzle;

FIG. 6 is a fragmentary sectional view of the third preferred embodiment of a mass spectrometer assembly implementing the method of ambient liquid mass spectrometry according to the present invention, illustrating relative positions of a micro-tube, a nozzle, and a pump;

FIG. 7 is a schematic side view of the fourth and sixth preferred embodiments of a mass spectrometer assembly implementing the method of ambient liquid mass spectrometry according to the present invention;

FIG. 8(a) is a mass spectrum, illustrating an experiment result of comparative example 1;

FIG. 8(b) is a mass spectrum, illustrating an experiment result of exemplary method 1;

FIG. 8(c) is a mass spectrum, illustrating an experiment result of exemplary method 2;

FIG. 9(a) is a mass spectrum, illustrating an experiment result of exemplary method 3;

FIG. 9(b) is a mass spectrum, illustrating an experiment result of exemplary method 4, where a liquid sample is under a first state;

FIG. 9(c) is a mass spectrum, illustrating an experiment result of exemplary method 4, where a liquid sample is under a second state;

FIG. 9(d) is a mass spectrum, illustrating an experiment result of exemplary method 5, where a liquid sample is under a first state;

FIG. 9(e) is a mass spectrum, illustrating an experiment result of exemplary method 5, where a liquid sample is under a second state;

FIG. 9(f) is a mass spectrum, illustrating an experiment result of exemplary method 6, where a liquid sample is under a first state;

FIG. 9(g) is a mass spectrum, illustrating an experiment result of exemplary method 6, where a liquid sample is under a second state;

FIG. 10(a) is a mass spectrum, illustrating an experiment result of exemplary method 7;

FIG. 10(b) is a mass spectrum, illustrating an experiment result of exemplary method 8;

FIG. 10(c) is a mass spectrum, illustrating an experiment result of exemplary method 9;

FIG. 10(d) is a mass spectrum, illustrating an experiment result of exemplary method 10;

FIG. 10(e) is a mass spectrum, illustrating an experiment result of exemplary method 11;

FIG. 10(f) is a mass spectrum, illustrating an experiment result of exemplary method 12;

FIG. 11(a) is a mass spectrum, illustrating an experiment result of exemplary method 13;

FIG. 11(b) is a deconvoluted mass spectrum of FIG. 11(a);

FIG. 11(c) is a mass spectrum, illustrating an experiment result of comparative example 2, where ESI-MS was used to conduct the mass spectrometric analysis;

FIG. 11(d) is a deconvoluted mass spectrum of FIG. 11(c);

FIG. 11(e) is a mass spectrum, illustrating an experiment result of comparative example 3, where MALDI-MS was used to conduct the mass spectrometric analysis;

FIG. 12(a) is a mass spectrum, illustrating an experiment result of exemplary method 14;

FIG. 12(b) is a deconvoluted mass spectrum of FIG. 12(a);

FIG. 12(c) is a mass spectrum, illustrating an experiment result of comparative example 4, where ESI-MS was used to conduct the mass spectrometric analysis;

FIG. 12(d) is a mass spectrum, illustrating an experiment result of comparative example 5, where MALDI-MS was used to conduct the mass spectrometric analysis;

FIG. 13(a) is a mass spectrum, illustrating an experiment result of exemplary method 15;

FIG. 13(b) is a deconvoluted mass spectrum of FIG. 14(a);

FIG. 13(c) is a mass spectrum, illustrating an experiment result of comparative example 6, where ESI-MS was used to conduct the mass spectrometric analysis;

FIG. 13(d) is a mass spectrum, illustrating an experiment result of comparative example 7, where MALDI-MS was used to conduct the mass spectrometric analysis;

FIG. 14(a) is a mass spectrum, illustrating an experiment result of exemplary method 16;

FIG. 14(b) is a deconvoluted mass spectrum of FIG. 14(a);

FIG. 14(c) is a mass spectrum, illustrating an experiment result of comparative example 8, where ESI-MS was used to conduct the mass spectrometric analysis;

FIG. 14(d) is a mass spectrum, illustrating an experiment result of comparative example 9, where MALDI-MS was used to conduct the mass spectrometric analysis;

FIG. 15(a) is a mass spectrum, illustrating an experiment result of exemplary method 17;

FIG. 15(b) is a deconvoluted mass spectrum of FIG. 16(a);

FIG. 15(c) is a mass spectrum, illustrating an experiment result of comparative example 10, where ESI-MS was used to conduct the mass spectrometric analysis;

FIG. 15(d) is a mass spectrum, illustrating an experiment result of comparative example 11, where MALDI-MS was used to conduct the mass spectrometric analysis;

FIG. 16(a) is a mass spectrum, illustrating an experiment result of exemplary method 18;

FIG. 16(b) is a deconvoluted mass spectrum of FIG. 17(a);

FIG. 17 is an X-Y coordinate diagram, illustrating experimental results of exemplary method 19, where X-axis represents (HbA1/Hb) values obtained using IC and Y-axis represents (HbA1/Hb) values obtained using ALMS analysis;

FIG. 18(a) is a mass spectrum, illustrating an experiment result of exemplary method 20; and

FIG. 18(b) is a deconvoluted mass spectrum of FIG. 18(a).

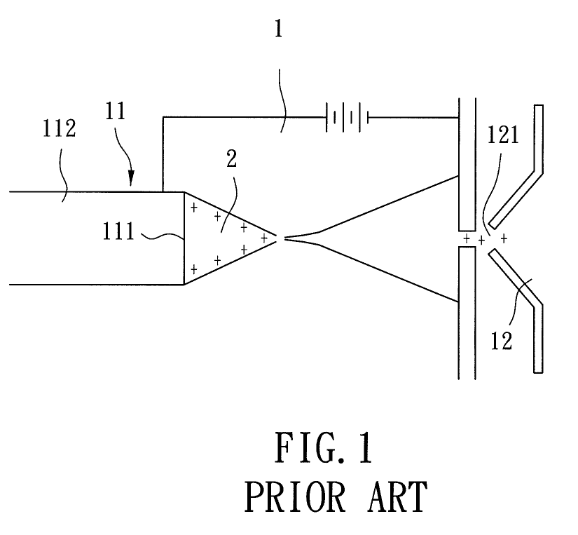

### DETAILED DESCRIPTION OF THE PREFERRED EMBODIMENTS

Before the present invention is described in greater detail, it should be noted herein that like elements are denoted by the same reference numerals throughout the disclosure. It is also noted herein that in the accompanying drawings, sizes of constituting elements and relative distances among the elements are not drawn to scale.

The applicant of the present invention incorporated, under atmospheric pressure, the previously described “laser desorption” (LD) technique, which requires to be conducted in vacuum, and the “electrospray ionization” (ESI) technique, which requires preparation of solution samples, to conduct detection directly on various kinds of solid samples. The obtained mass spectrometric analysis results established that this novel ionization technique, referred to as “electrospray-assisted laser desorption ionization” (ELDI), is practicable, wherein the limitation imposed on the operational condition of laser desorption (i.e., in vacuum) is no longer required, and the sample preparation (i.e., desalination) necessary for electrospray ionization is also eliminated. Therefore, through the electrospray-assisted laser desorption ionization technique, satisfactory analytic results can be obtained under atmospheric pressure on a solid sample. The mass spectrometry method utilizing the electrospray-assisted laser desorption ionization technique is called the electrospray-assisted laser desorption ionization mass spectrometry (ELDI-MS).

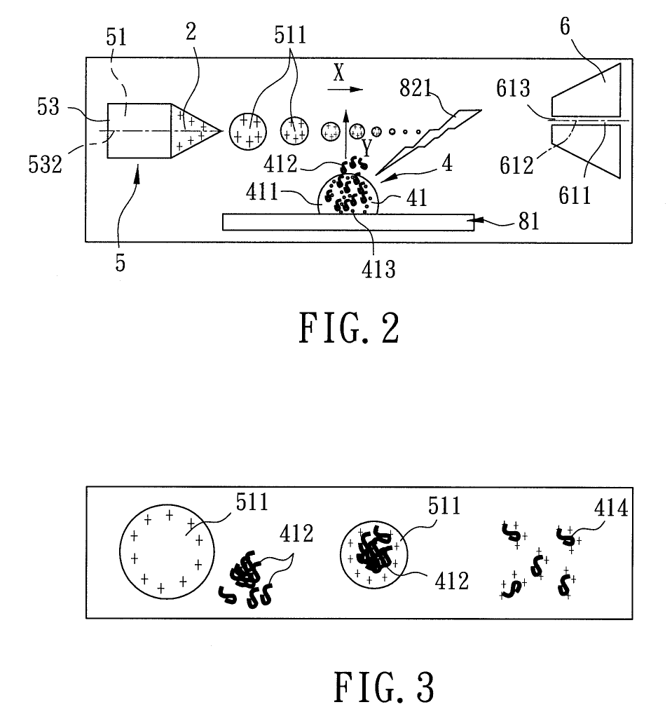

In this invention, a suitable matrix is added to the liquid sample prior to conducting the electrospray-assisted laser desorption ionization mass spectrometric analysis. Particularly, as shown in FIGS. 2 to 4, while an electrospray ionization process was implemented to form sequentially multiple-charged liquid drops 511 of a liquid electrospray medium 51, a laser beam 821 was irradiated onto a liquid sample 4, which includes a solution 41 that contains the analytes 412 and a material 413 serving as a matrix (also referred to as a matrix material 413) for absorbing laser energy, and which is disposed in the passage way of a receiving unit 6 adapted to admit therein ionized analytes 414 that are derived from the liquid sample 4 for mass spectrometric analysis. Surprisingly, the obtained mass spectrometric analysis results established that this novel technique, referred to as “ambient liquid mass spectrometry” (ALMS), is practicable directly on liquid samples under atmospheric pressure.

As the liquid sample 4 is irradiated by the laser beam 821, laser energy which is absorbed by the matrix material 413 contained in the solution 41 of the liquid sample 4, is presumably passed on to at least one of the analytes 412 via the matrix material 413 so that said at least one of the analytes 412 is desorbed, and is occluded in the multiple-charged liquid drops 511 formed during the electrospray ionization process. As a result of dwindling in size of the multiple-charged liquid drops 511 when approaching the receiving unit 6, charges 511 of the liquid drops 511 will pass on to said at least one of the analytes 412 occluded therein to form a corresponding ionized analyte 414. The ionized analyte 414 is received by the receiving unit 6 for mass spectrometric analysis thereby.

Moreover, since water molecules are highly absorbent to infrared (IR) light, the water molecules contained in an aqueous solution might possibly serve as the matrix for absorbing laser energy and transferring the laser energy to the analytes. Therefore, with procedures similar to those disclosed hereinabove, an infrared laser beam was employed to irradiate directly on an aqueous solution. Accurate mass spectrometric analysis results were obtained by using the infrared laser beam as the laser energy.

In sum, the concept presented by the applicant is that by preparing a liquid sample including a solution that contains a plurality of analytes and a material serving as a matrix for absorbing laser energy, and by subsequently irradiating the liquid sample with a laser beam, at least one of the analytes contained in the solution is desorbed. Then, by incorporating the electrospray ionization process, the desorbed analyte is ionized to form a corresponding ionized analyte for subsequent mass spectrometric analysis. Further, when the solution is an aqueous solution containing a plurality of water molecules, by irradiating an infrared laser beam at the liquid sample, satisfactory results can be obtained.

The abovedescribed novel method of mass spectrometry, named “Ambient Liquid Mass Spectrometry” (ALMS), apparently opens up a new era for mass spectrometric analysis of liquid samples, especially on aqueous solutions containing proteins, under atmospheric pressure. Operation procedure of ambient liquid mass spectrometry is relatively simple and rapid, and resolution thereof is higher than that of ESI-MS. Ambient liquid mass spectrometry is capable of accurately detecting molecular weights of analytes, even when the analytes are macromolecules, such as proteins, thereby showing an outstanding ability in protein identification. These advantages allow ambient liquid mass spectrometry to quickly analyze biochemical and medical liquid samples so as to obtain reliable results, which is extremely favorable in relevant applications, such as immediate diagnosis of diseases.

As shown in FIGS. 2 to 4, the method for ambient liquid mass spectrometry according to the present invention can be implemented by performing the following steps:

Place a liquid sample 4, on a sample stage 81, that includes a solution 41 containing a plurality of analytes 412 and a material 413 serving as a matrix (also referred to as a matrix material 413) for absorbing laser energy so as to assist in desorption of the analytes 412. In particular, the solution 41 includes a solvent 411 that contains the analytes 412 and the material 413 therein.

Provide an electrospray unit 5 that includes a reservoir 52 for accommodating a liquid electrospray medium 51, and a nozzle 53 which is disposed downstream of the reservoir 52, and which is configured to sequentially form liquid drops 511 of the electrospray medium 51 thereat.

Provide a receiving unit 6 that is spaced apart from the nozzle 53 of the electrospray unit 5 for receiving and analyzing ionized analytes 414 derived from the liquid sample 4.

Provide a detector 7 for detecting signals generated as a result of analyzing the ionized analytes 414 by the receiving unit 6, and for generating a mass spectrum of the liquid sample 4 from the signals.

Establish between the nozzle 53 of the electrospray unit 5 and the mass analyzer 61 of the receiving unit 6 a potential difference which is of an intensity such that the liquid drops 511 are laden with a plurality of electric charges, and such that the liquid drops 511 are forced to leave the nozzle 53 as multiple-charged ones for heading toward the receiving unit 6 along a traveling path (X).

Irradiate the liquid sample 4 with a laser beam 821 such that at least one of the analytes 412 contained in the solution 411 of the liquid sample 4 is desorbed to fly along a flying path (Y) which intersects the traveling path (X) so as to enable said at least one of the analytes 412 to be occluded in the multiple-charged liquid drops 511, and such that as a result of dwindling in size of the multiple-charged liquid drops 511 when approaching the mass analyzer 61 of the receiving unit 6 along the traveling path (X), charges of the liquid drops 511 will pass on to said at least one of the analytes 412 to form a corresponding one of the ionized analytes 414.

Herein, the polarity of the electric charges carried by the liquid drops 511 depends on the electric field direction established by the potential difference present between the nozzle 53 of the electrospray unit 5 and the mass analyzer 61 of the receiving unit 6. In the example illustrated in FIGS. 2 to 4, the liquid drops 511 are laden with positive charges. In addition, the charges laden in the liquid drops 511 are mostly multivalent, but can also be univalent at times.

The electrospray medium forming the liquid drops is a solution normally used in electrospray methods. An example of the electrospray medium is a solution containing a volatile liquid such that the liquid portion in the liquid drops can vaporize prior to the receipt of the ionized analytes by the mass analyzer. Further, in order to help dissolve protein molecules and avoid interference due to an addition of salt in the volatile liquid, and to simplify the resultant mass spectrum, the volatile liquid is preferably one with a low polarity, such as isoacetonitrile, acetone, alcohol, etc.

In order to facilitate interpretation of the mass spectra, a “positive ion mode” involving charged liquid drops that contain protons (H⁺) is normally used for mass spectrometric analysis incorporating the “electrospray” technique. This mode is achieved by establishing the potential difference between the nozzle of the electrospray unit and the mass analyze of the receiving unit such that the electric field direction points away from the nozzle toward the mass analyzer. The potential difference should be established with respect to the design of the mass analyzer, for example, by applying a voltage above 2 kV at the nozzle and grounding the mass analyzer, or by grounding the nozzle and applying a −4 kV voltage at the mass analyzer.

Thus, if it is desired to increase the probability of the analytes being ionized after desorption, it is preferable for the electrospray medium to include a solution containing protons (H⁺). The protons can be obtained through addition of an acid into the solution. Preferably, the acid can be selected from the group consisting of formic acid, acetic acid, trifluroacetic acid, and a combination thereof.

In another aspect, if, for instance, the analyte in the liquid sample is a protein, and it is desired to investigate the un-denatured state of the protein, the electrospray medium is preferably a solution that contains a volatile liquid and that does not contain an acid, such as methanol aqueous solution.

For reasons listed above, based on different requirements, “an aqueous solution containing methanol and acetic acid” and a “methanol aqueous solution” are used as the electrospray medium in the embodiments of the present invention, respectively. In addition, it is assumed that the ion portion of the obtained analytes is multivalent with each charge being contributed by a proton (H⁺).

One of the main objects that the method of ambient liquid mass spectrometry according to the present invention aims at is the detection of analytes from a liquid sample including a solution that contains the analytes and a material serving as a matrix for assisting in the desorption of at least one of the analytes. Therefore, no limitation is imposed on the types of solutions and the kinds of analytes detectable for the implementations of the present invention. Whether the solution is an aqueous solution, contains an organic solvent, or is a body fluid secreted by an organism and having a complicated composition (also referred to as an organism's body fluid), and whether the analytes are macroscopic molecules such as proteins, or are microscopic molecules such as ordinary compounds, mass spectrometric analysis results can be obtained through implementing the method of ambient liquid mass spectrometry according to the present invention.

Therefore, the liquid sample under study can include various solutions, including organism's body fluids, chemical solutions, environment sampling solutions, or various eluates from liquid chromatography, etc. Preferably, the organism's body fluid can be selected from the group consisting of blood, tear, milk, perspiration, intestinal juice, brains fluid, spinal fluid, lymph, pus, blood serum, saliva, nasal mucus, urine, and excrement. In some embodiments of the present invention, the liquid sample under study can include blood, tear, milk, or blood serum. When the liquid sample under study includes a chemical solution, the chemical solution can be insulin, myoglobin, cytochrome c, or a protein solution made from a combination thereof, as illustrated in some of the embodiments disclosed herein. The chemical solution can also be an organic solution, where the solvent of the organic solution is not limited to any organic solvents, and the analytes of the organic solution are not limited to any organic compounds. According to some of the embodiments disclosed herein, the chemical solution is selected from a methanol solution of hemin, a tetrahydrofuran (THF) solution of 18-crown-6-ether, an ethyl acetate solution of 1-hexadecylamine, an ethyl acetate solution of Methyl (triphenyl-phosphoranylidene), a toluene solution of cinnamic acid benzyl, and an n-hexane solution of cetylpyridinium chloride.

Preferably, the material serving as the matrix is made from a material that is non-transmissible by laser. More preferably, the material serving as the matrix is selected from the group consisting of gold, carbon, cobalt, iron, 2,5-dihydroxybenzoic acid (2,5-DHB), 3,5-dimethoxy-4-hydroxycinnamic acid (sinapinic acid, (SA)), α-cyano-4-hydroxycinnamic acid (α-CHC), and a combination thereof.

Better results are obtained when the material serving as the matrix has a particle diameter greater than a particular size. Preferably, the particle diameter of the material serving as the matrix ranges from 50 nm to 50 μm. In some embodiments of the present invention, the material serving as the matrix is selected from the group consisting of gold nano-particles, carbon powders, 2,5-DHB, SA, α-CHC, and a combination thereof.

In particular, when the solution included in the liquid sample is an aqueous solution, water molecules contained in the aqueous solution would be the material serving as the matrix, and by irradiating with an infrared laser beam, the analytes contained in the aqueous solution can be desorbed. Incidentally, it is also practicable to add another material purposely into an aqueous solution to serve as the matrix. However, when it is desired to analyze an organic solution, a material serving as a matrix is added into the solution to form the liquid sample under study prior to implementing the method of ambient liquid mass spectrometry according to the present invention. Descriptions related to detailed operational practices and mechanisms for the method of ambient liquid mass spectrometry will be described in subsequent embodiments.

The mass spectrometer assembly according to the present invention implements the method of ambient liquid mass spectrometry that has been described hereinabove. The mass spectrometer assembly includes a receiving unit including a mass analyzer, an electrospray unit, a voltage supplying member, and a laser desorption device. The laser desorption device includes a sample stage on which the liquid sample is placed, and a laser transmission mechanism disposed to irradiate the liquid sample.

The main components of the mass spectrometer assembly can be reconstructed as necessary according to the user's needs, and the types and relative positions of the components can be varied. For instance, the sample stage and the laser transmission mechanism of the laser desorption device, the mass analyzer of the receiving unit, and the electrospray unit can be designed to be movable such that adjustments of the positions thereof can be made by the user as are required. Therefore, the relative positions or distances among the various components of the mass spectrometer assembly according to the present invention need to be those such that the following objectives are achieved: at least one of the analytes is desorbed from the liquid sample; and said at least one of the analytes is capable of being occluded in multiple-charged liquid drops of an electrospray medium formed at a nozzle of the electrospray unit under a potential difference established by the voltage supplying member such that the charges of the liquid drops are passed on to said at least one of the analytes as a result of dwindling in size of the multiple-charged liquid drops when approaching the mass analyzer of the receiving unit along a traveling path so as to form a corresponding ionized analyte.

In order to maintain good directionality of the electric field resulting from the potential difference established between the nozzle of the electrospray unit and the mass analyzer of the receiving unit during operation of the mass spectrometer assembly so as to ensure successful entrance of the ionized analytes into the receiving unit, the sample stage of the laser desorption device is preferably not grounded.

The sample stage is disposed to provide placement of the liquid sample thereon. As for the form of the sample stage, it can, for instance, include a support member that is made from a material non-transmissive by laser. In addition, in order to avoid interfering the electric field resulting from the potential difference established between the nozzle of the electrospray unit and the receiving unit, it is suggested that the support member be made from a non-metallic material, such as Teflon or plastic. For the purpose of ensuring that most of the laser beam energy is concentrated on the liquid sample, the support member is provided for placement of the liquid sample, and has a support surface for placement of the liquid sample directly thereon such that an operator of the mass spectrometer assembly can begin performing the method of ambient liquid mass spectrometry by dripping the liquid sample on the support surface.

Alternatively, in order to facilitate successive mass spectrometric analysis on several liquid samples, the sample stage of the laser desorption device can include a movable track, and a support member mounted movably on the track. The support member has the liquid samples disposed thereon such that the liquid samples move with the supporting member along the track. Therefore, computer control can be implemented with the sample stage in order to automate the process of transporting the liquid samples to a specific point for analysis using the method of ambient liquid mass spectrometry, thereby increasing analysis efficiency and reducing the cost of labor. Since relative instrumentation techniques for the sample stage are known in the art, further details of the same are omitted herein for the sake of brevity.

The mass analyzer of the receiving unit has a conduit for receiving and analyzing the ionized analytes derived from the liquid sample. The mass analyzer receives the ionized analytes through the conduit, separates the ionized analytes according to their m/z values (mass-to-charge ratios), and generates corresponding signals for the ionized analytes. Preferably, the mass analyzer is selected from the group consisting of an ion trap mass analyzer, a quadrupole time-of-flight mass analyzer, a triple quadrupole mass analyzer, an ion trap time-of-flight mass analyzer, a time-of-flight/time-of-flight mass analyzer, and a Fourier transform ion cyclotron resonance (FTICR) mass analyzer. In this embodiment, the mass analyzer is one of an ion trap mass analyzer and a quadrupole time-of-flight mass analyzer.

The mass spectrometer assembly further includes a detector for detecting the signals generated as a result of analyzing the ionized analytes by the mass analyzer. After detecting the signals, the detector converts the signals into a mass spectrum. Preferably, the detector is an electron multiplier as illustrated in the embodiments of the present invention.

The electrospray unit includes a reservoir for accommodating the liquid electrospray medium, and the nozzle which is disposed downstream of the reservoir, and which is configured to sequentially form the liquid drops of the electrospray medium threat. Preferably, the nozzle is a capillary formed with an outlet that is configured to sequentially form the liquid drops of the electrospray medium thereat. The electrospray unit further includes a pump disposed downstream of the reservoir and upstream of the nozzle for drawing the electrospray medium into the nozzle. In this embodiment, the nozzle is a capillary that is made from a metal material.

The voltage supplying member is disposed to establish between the nozzle of the electrospray unit and the mass analyzer of the receiving unit a potential difference which is of an intensity such that the liquid drops are laden with a plurality of charges, and such that the liquid drops are forced to leave the nozzle as multiple-charged ones for heading toward the mass analyzer of the receiving unit along the traveling path.

Preferably, the nozzle of the electrospray unit is a capillary formed with an outlet that is configured to sequentially form the liquid drop of the electrospray medium thereat. In addition, the electrospray unit further includes a pump disposed downstream of the reservoir for drawing the electrospray medium out of the reservoir, and a micro-tube that has a tubular body connected between and disposed in fluid communication with the pump and the capillary, and a center portion connected to the tubular body and coupled to the voltage supplying member such that the potential difference is established between the micro-tube and the mass analyzer of the receiving unit. This configuration is suitable for a capillary that is made from a non-conductive material (e.g., glass).

No limitation is imposed upon the wavelength, energy, and frequency of the laser beam transmitted by the laser transmission mechanism of the laser desorption device, as long as the laser beam is capable of desorbing at least one of the analytes from the liquid sample when the latter is irradiated thereby. Preferably, the laser transmission mechanism is selected from the group consisting of an ultraviolet (UV) laser, an infrared (IR) laser, a nitrogen laser, an argon ion laser, a helium-neon laser, a carbon dioxide (CO₂) laser, and a garnet (Nd:YAG) laser. In one embodiment of the present invention, the laser transmission mechanism is an ultraviolet laser for providing an ultraviolet laser beam.

It should be noted herein that when the laser transmission mechanism is capable of emitting an infrared laser beam (i.e., when the laser transmission mechanism is an infrared laser), at least one analyte can be desorbed from a liquid sample including an aqueous solution so as to proceed with the analysis using the method of ambient liquid mass spectrometry without adding another material to serve as the matrix for assisting in the desorption of the analyte.

Each of the components of the mass spectrometer assembly according to the present invention can be designed to be movable so as to permit adjustments of the positions thereof by the user as are required, such that relative positions or distances among the various components of the mass spectrometer assembly can be determined. Similarly, parameters, such as the energy, frequency, incident angle of the laser beam irradiated by the laser transmission mechanism, and the composition and flow rate of the electrospray medium, etc., can be adjusted according to the objectives aimed, so as to obtain optimal detection results.

When the nozzle of the electrospray unit is a capillary formed with an outlet that is configured to sequentially form the liquid drop of the electrospray medium thereat, it is preferable for the electrospray unit and the laser desorption device to be disposed such that central axes of the capillary and the conduit of the mass analyzer are substantially parallel to each other, and such that a distance between the outlet of the capillary and an entrance of the conduit falls between 0.5 mm and 20 mm. In order to ensure successful ionization of at least one analyte desorbed from the liquid sample, preferably, the shortest distance between the outlet of the capillary and the liquid sample, which is placed on the sample stage, falls between 0.1 mm to 2 mm.

### Preferred Embodiments

The present invention is described in greater detail hereinbelow with respect to the preferred embodiments and exemplary applications presented. It should be noted herein that the embodiments and exemplary applications are for illustrative purposes only, and should not be considered as limitations imposed on the present invention.

### Chemicals and Equipments Used

The preferred embodiments, exemplary methods, and comparison (experiment) examples were conducted using the following chemicals and equipments:
1. Laser Transmission Mechanism:
   a. Ultraviolet (UV) Laser model no. VSL-337i, manufactured by Laser, Science Inc. of the United States. The laser beams transmitted by the ultraviolet laser have a wavelength of 337 nm, a frequency of 10 Hz, a pulse duration of 4 ns, and a pulse energy of 100 μJ.
   b. Infrared (IR) Laser model no. LS-2130SHP, manufactured by LOTIS TII of Russia. The laser beams transmitted by the infrared laser have a wavelength of 1064 nm, a frequency of 2 Hz, a pulse duration of 0.5 ns, and a pulse energy of 50 mJ.
2. Mass Analyzer (including the Detector): Quadrupole Time-of-Flight Mass Analyzer model no. BioTOF-Q, manufactured by Bruker Dalton company of Germany.
3. Electrospray Medium:
   a. Methanol: an HPLC solvent manufactured by Merck company of Germany.
   b. acetic acid: an HPLC solvent manufactured by Mallinckrodt company of Germany.
4. Analytes:
   a. Protein Standard: insulin (molecular weight of 5733), myoglobin (molecular weight of 17566), lysozyme (molecular weight of 14305), and cytochrome c (molecular weight of 12232), all of which are high purity protein standards with concentrations of above 95% and manufactured by Sigma-Aldrich company of the United States.
   b. Hemin: molecular weight of 652.0, model no. H-2250 manufactured by Aldrich company of the United States.
   c. 18-crown-6-ether: molecular weight of 264.32, model no. C0860 manufactured by Tokyo Chemical Industry Co., Ltd. of Japan.
   d. 1-hexadecylamine: molecular weight of 241.46, model no. H740-8 manufactured by Aldrich company of the United States.
   e. Methyl(triphenyl-phosphoranylidene) acetate: molecular weight of 334, model no. 64941 manufactured by Fluka company.
   f. Cinnamic acid benzyl ester: molecular weight of 260, model no. CO₃₅₈ manufactured by Tokyo Chemical Industry Co., Ltd. of Japan.
   g. Cetylpyridinium chloride: molecular weight of 339.99 (note: Chemical equation of cetylpyridinium chloride is C21H38N-Cl with an average molecular weight of 339.99 and a monoisotope molecular weight of 339.27, where C21H38N(304.30) is a cation and Cl(34.97) is an anion. Since a mass spectrometer detects cations, the molecular weight obtained is not 339.99), model no. 145-100G manufactured by AJAX Chemical.
   h. Chalcone: molecular weight of 208, model no. 136123 manufactured by Aldrich company of the United States.
5. Solvents:
   a. Methanol (identical to the above)
   b. Tetrahydrofuran (THF): model no. 9440-03 manufactured by J. T. Baker company of the United States.
   c. Ethyl acetate: model no. 9282-03 manufactured by J. T. Baker company of the United States.
   d. Methylene dichloride: a HPLC solvent manufactured by Merck company of Germany.
   e. Tolene: an HPLC solvent manufactured by J. T. Baker company of the United States.
   f. N-hexane: an HPLC solvent manufactured by J. T. Baker company of the United States.
6. Other Chemicals:
   a. H₂O₂: concentration of 30%, model no. 31642 manufactured by Riedel-de Haen company.
   b. NaOH: model no. SK371842 manufactured by Nihon Shiyaku Industries Ltd.
7. Matrix Material:
   a. Carbon powders: model no. 4206A manufactured by Merck company of Germany; particle diameter of below Sgm.
   b. Gold nano-particles: provided privately; particle diameter of approximately 56 nm.
   c. α-cyano-4-hydroxycinnamic acid (α-CHC), an HPLC material manufactured by Sigma-Aldrich company of the United States.
   d. 2,5-dihydroxybenzoic acid (2,5-DHB):model no. D0569 manufactured by Tokyo Chemical Industry Co., Ltd. of Japan.
   e. 3,5-dimethoxy-4-hydroxycinnamic acid (Sinapinic acid (SA)): model no. D1765 manufactured by Tokyo Chemical Industry Co., Ltd. of Japan.
8. Matrix-Assisted Laser Desorption Ionization Mass Spectrometer (MALDI-MS): model no. Autoflex MALDI/TOF, manufactured by Bruker Dalton company of Germany, and suitable for analyzing macromolecules in the linear mode.
9. Electrospray Ionization Mass Spectrometer (ESI-MS): including an electrospray unit, a mass analyzer, and a detector; the electrospray unit, the mass analyzer and the detector are identical to those used in the embodiments of the mass spectrometer assembly implementing the method of ambient liquid mass spectrometry according to the present invention.
10. Relevant chemicals or equipments for bacterial extraction:
   a. Glass beads: model no. 11079101 manufactured by Biospec Products, Inc.; diameter of 100 μm.
   b. Sonicator: model no. XL2020 manufactured by Heat Systems, Inc.
   c. Centrifuge: model no. DSC-1524SDT TFA manufactured by Digisystem Laboratory Instruments, Inc.
   d. Trifluroacetic acid: an analysis class acid with model no. 61030 manufactured by Riedel-de Haen company.
   e. Acetonitrile (ACN): an HPLC material with model no. UN1648 manufactured by Merck company of Germany.

### First Preferred Embodiment—Mass Spectrometer Assembly Implementing the Method of Ambient Liquid Mass Spectrometry

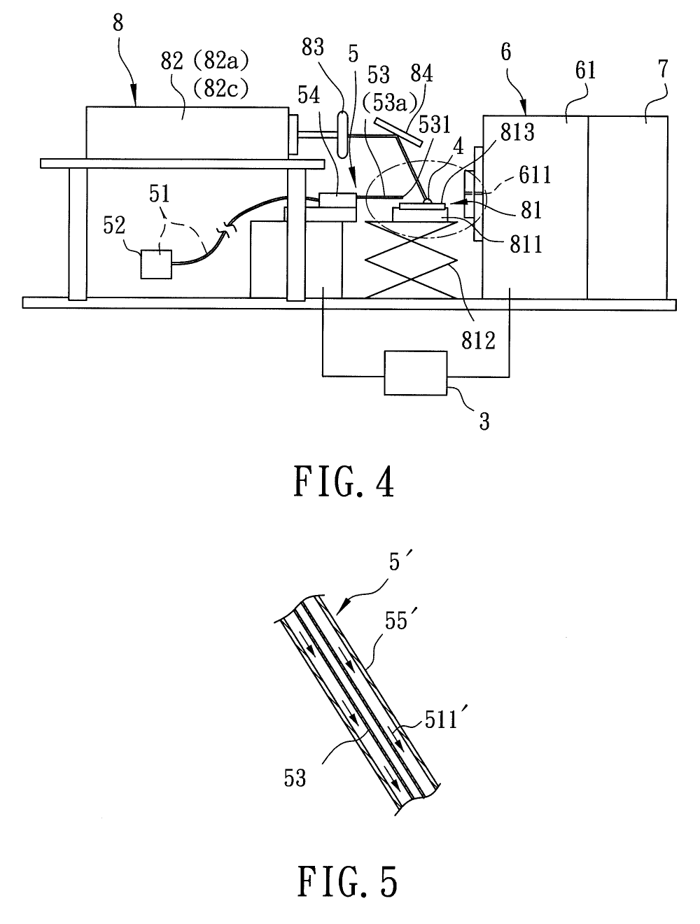

Referring to FIG. 4, the first preferred embodiment of a mass spectrometer assembly implementing the method of ambient liquid mass spectrometry is adapted to conduct mass spectrometric analysis on a liquid sample 4. With reference back to FIG. 2 and FIG. 3, the liquid sample 4 includes a solution 41 including a solvent that contains a plurality of analytes 412 and a material 413 serving as a matrix (also referred to as a matrix material 413) for assisting in desorption of at least one of the analytes 412. The mass spectrometer assembly includes an electrospray unit 5, a receiving unit 6, a voltage supplying member 3, and a laser desorption device 8.

The laser desorption device 8 includes a sample stage 81 on which the liquid sample 4 is placed, a laser transmission mechanism 82 that is capable of transmitting a laser beam 821 and that is disposed to irradiate the liquid sample 4, a lens 83 that is disposed to receive the laser beam 821 from the laser transmission mechanism 82 for focusing the energy carried by the laser beam 821, and a reflector 84 that is disposed to change the path of the laser beam 821. In this embodiment, the laser transmission mechanism 82 is an ultraviolet laser transmission mechanism 82a that is capable of transmitting the laser beam 821. In principle, the laser desorption device 8 is designed as long as the laser desorption device 8 is capable of irradiating the liquid sample 4 such that, upon irradiation, at least one of the analytes 412 contained in the solution 41 of the liquid sample 4 is desorbed. Therefore, in practice, the lens 83 and the reflector 84 can be varied in position as required, or can even be completely eliminated according to other embodiments of the present invention.

The sample stage 81 of the laser desorption device 8 includes a support member 811 that is made from a material non-transmissive by laser, and a hoister platform 812 that is provided for mounting of the support member 811 thereon, and that is movable. The support member 811 is provided for placement of the liquid sample 4, and has a support surface 813 for placement of the liquid sample 4 directly thereon. This way, an operator can begin performing the method of ambient liquid mass spectrometry by dripping the liquid sample 4 on the support surface 813.

The receiving unit 6 is disposed to admit therein ionized analytes 414 that are derived from the liquid sample 4, and that are to be analyzed for mass spectrometric analysis. The receiving unit 6 includes a mass analyzer 61 disposed for analyzing the ionized analytes 414. The mass analyzer 61 is formed with a conduit 611 that is in air communication with the environment. The detector 7 is disposed to receive signals generated by the mass analyzer 61 as a result of analyzing the ionized analytes 414 so as to generate a mass spectrometric analysis result, i.e., a mass spectrum.

The electrospray unit 5 includes a reservoir 52 for accommodating a liquid electrospray medium 51, a nozzle 53 (in the embodiments of the present invention, the nozzle 53 is a capillary 53a) which is disposed downstream of the reservoir 52, and which is configured to sequentially form liquid drops 511 of the electrospray medium 51 thereat, and a pump 54 disposed downstream of the reservoir 52 and upstream of the nozzle 53 for drawing the electrospray medium 51 into the nozzle 53. The nozzle 53 is spaced apart from the mass analyzer 61 of the receiving unit 6 in a longitudinal direction so as to define a traveling path (X).

The voltage supplying member 3 is disposed to establish between the nozzle 53 of the electrospray unit 5 and the mass analyzer 61 of the receiving unit 6 a potential difference which is of an intensity such that the liquid drops 511 are laden with a plurality of charges, and such that the liquid drops 511 are forced to leave the nozzle 53 as multiple-charged ones for heading toward the mass analyzer 61 along the traveling path (X).

In the first preferred embodiment, the nozzle 53 is made from a metal material, and a first central axis 532 of the nozzle 53 and a second central axis 612 of the conduit 611 in the mass analyzer 61 are substantially parallel to each other. The support member 811 of the sample stage 81 extends in the longitudinal direction such that the support surface 813 thereof defines a leveled plane in the longitudinal direction. The distance between projections of an outlet 531 of the nozzle 53 and an entrance 613 into the conduit 611 of the mass analyzer 61 on the leveled plane is approximately 8 mm. In addition, when the liquid sample 4 is placed on the support surface 813 of the support member 81, the shortest distance between the liquid sample 4 and the outlet 531 of the nozzle 53 is 1.5 mm.

When the laser transmission mechanism 82 of the laser desorption device 8 transmits the laser beam 821 to irradiate the liquid sample 4, upon irradiation, at least one of the analytes 412 contained in the solution 41 of the liquid sample 4 is desorbed to fly along a flying path (Y) which intersects the traveling path (X) so as to enable said at least one of the analytes 412 to be occluded in the multiple-charged liquid drops 511. As a result of dwindling in size of the multiple-charged liquid drops 511 when approaching the mass analyzer 61 of the receiving unit 6 along the traveling path (X), charges of the liquid drops 511 will pass on to said at least one of the analytes 412 to form a corresponding one of the ionized analytes 414. The ionized analytes 414 enter the mass analyzer 61 via the entrance 613 into the conduit 611 for subsequent mass spectrometric analysis.

### Second Preferred Embodiment

With reference to FIG. 5, the second preferred embodiment of a mass spectrometer assembly implementing the method of ambient liquid mass spectrometry according to the present invention is similar to the first preferred embodiment. The only difference between the first and second preferred embodiments is that the electrospray unit 5′ of the second preferred embodiment further includes an airstream supplying mechanism 55′ for accelerating vaporization of the multiple-charged liquid drops 511 (refer to FIGS. 2 to 4) to result in dwindling in size thereof when approaching the mass analyzer 61 (refer to FIG. 5) along the traveling path (X). The airstream supplying mechanism 55′ surrounds the nozzle 53, and supplies a nitrogen airstream 551′. In particular, the temperature of the nitrogen airstream 551′ can be controlled by the user between the room temperature and 325° C. as is required.

### Third Preferred Embodiment

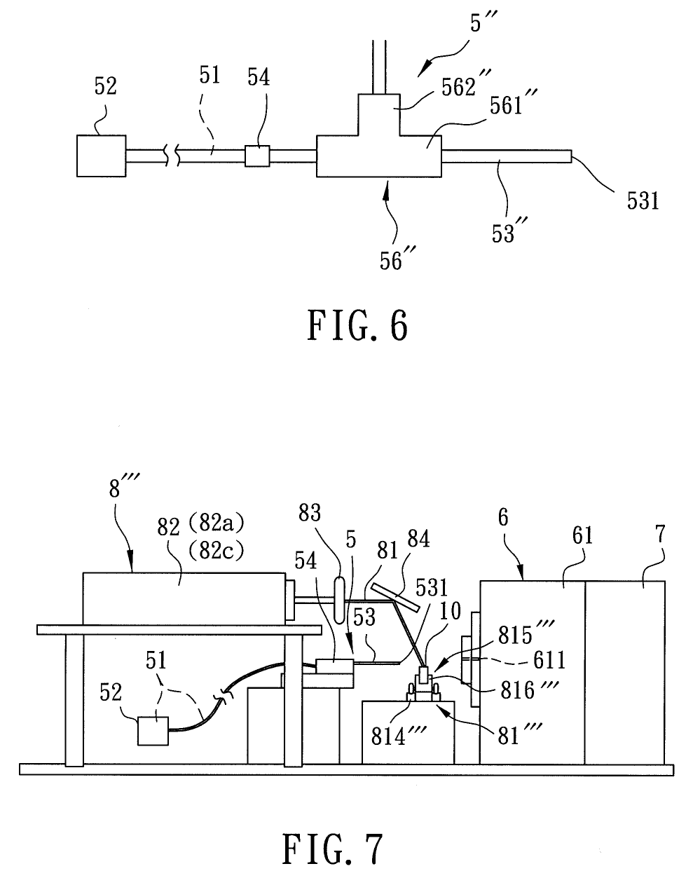

As shown in FIG. 6, the third preferred embodiment of a mass spectrometer assembly implementing the method of ambient liquid mass spectrometry according to the present invention is similar to the first preferred embodiment. The difference between the first and third preferred embodiments is that the nozzle 53″ of the electrospray unit 5″ of the third preferred embodiment is made from a non-metal material, and the electrospray unit 5″ further includes a micro-tube 56″. The micro-tube 56″ includes a tubular body 561″ connected between and disposed in fluid communication with the pump 54 and the nozzle 53″, and a center portion 562″ connected to the tubular body 561″ and coupled to the voltage supplying member 3 (refer to FIG. 4) such that the potential difference is established between the micro-tube 56″ and the mass analyzer 61 of the receiving unit 6.

### Fourth Preferred Embodiment

Referring to FIG. 7, the fourth preferred embodiment of a mass spectrometer assembly implementing the method of ambient liquid mass spectrometry according to the present invention is similar to the first preferred embodiment. The difference between the first and fourth preferred embodiments is that the sample stage 81′″ of the laser desorption device 8′″ includes a movable track 814′″, and a support member set 815′″ including a plurality of support members 816′″ (only one is visible in FIG. 7) connected in sequence and mounted movably on the track 814′″.

To conduct mass spectrometric analysis using the mass spectrometer assembly of the fourth preferred embodiment, a plurality of liquid samples 4 (as shown in FIG. 4) are first contained in containers 10 (e.g., test tubes or centrifuge tubes) (only one is visible in FIG. 7), respectively. Subsequently, each of the containers 10 is disposed on a corresponding one of the support members 816′″. Through control of a computer software, the support members 816′″ move along the track 814′″, carrying the liquid samples 4 thereon, such that the liquid samples 4 are sequentially disposed at a predefined location set by the operator. When each of the liquid samples 4 is disposed at the predefined location, the liquid sample 4 is irradiated by the laser beam 821 transmitted by the laser transmission mechanism 82 of the laser desorption device 8, and subsequent mass spectrometric analysis is conducted.

It should be noted herein that only one support member 816′″ and one container 10 are visible in FIG. 7 due to the direction of observation.

### Fifth Preferred Embodiment

Referring to FIG. 4, the fifth preferred embodiment of a mass spectrometer assembly implementing the method of ambient liquid mass spectrometry according to the present invention is similar to the first preferred embodiment. The only difference between the first and the fifth preferred embodiments is that the laser transmission mechanism of the fifth preferred embodiment is an infrared (IR) laser 82c instead of the ultraviolet laser 82a as in the first preferred embodiment.

### Sixth Preferred Embodiment

Referring to FIG. 6, the sixth preferred embodiment of a mass spectrometer assembly implementing the method of ambient liquid mass spectrometry according to the present invention is similar to the fourth preferred embodiment. The only difference between the fourth and the sixth preferred embodiments is that the laser transmission mechanism of the sixth preferred embodiment is the infrared (IR) laser 82c (as shown in FIG. 4) instead of the ultraviolet laser 82a.

### Exemplary Methods and Comparative Examples

Presented hereinbelow are exemplary methods for the method of ambient liquid mass spectrometry according to the present invention, along with several comparative examples. In the exemplary methods and comparative examples, the liquid samples and electrospray medium are prepared following a certain proportion, or are obtained directly, under room temperature and atmospheric pressure. If it is not particularly pointed out, the liquid sample includes an aqueous solution, and the composition of the electrospray medium is [water:methanol:acetic acid=50:50:0.1], and the flow rate of the electrospray medium is 150 μL per minute.

Further, if it is not particularly pointed out, the exemplary methods and comparative examples are conducted according to the third preferred embodiment of the present invention. In addition, the mass analyzer conducts the scans with a 2s/scan scanning rate. For each liquid sample presented, the molecular weight of the solvent is excluded from a scanning range of the mass analyzer.

In addition, the comparative examples include those conducted using a matrix-assisted laser desorption ionization mass spectrometer (MALDI-MS). Each sample used in these MALDI-MS comparative examples was prepared by dehydrating the corresponding liquid sample into a dehydrated sample. The comparative examples further include those conducted using an electrospray ionization mass spectrometer (ESI-MS). The ESI-MS conducts mass spectrometric analysis directly on a protein sample solution with a 150 μL/minute flow rate for the sample solution.

### Exemplary Methods 1 and 2 and Comparative Example 1—Mass Spectrometric Analysis Conducted on Protein Standard Sample Solutions

In exemplary methods 1 and 2 and in comparative example 1, the electrospray medium used was a 20 vol % methanol aqueous solution, and the matrix material for the liquid sample was in the form of carbon powders with varying concentrations, respectively. The composition of the liquid sample used, and the figure number of corresponding mass spectrum for each of exemplary methods 1 and 2 and comparative example 1 are tabulated in Table 1 below.

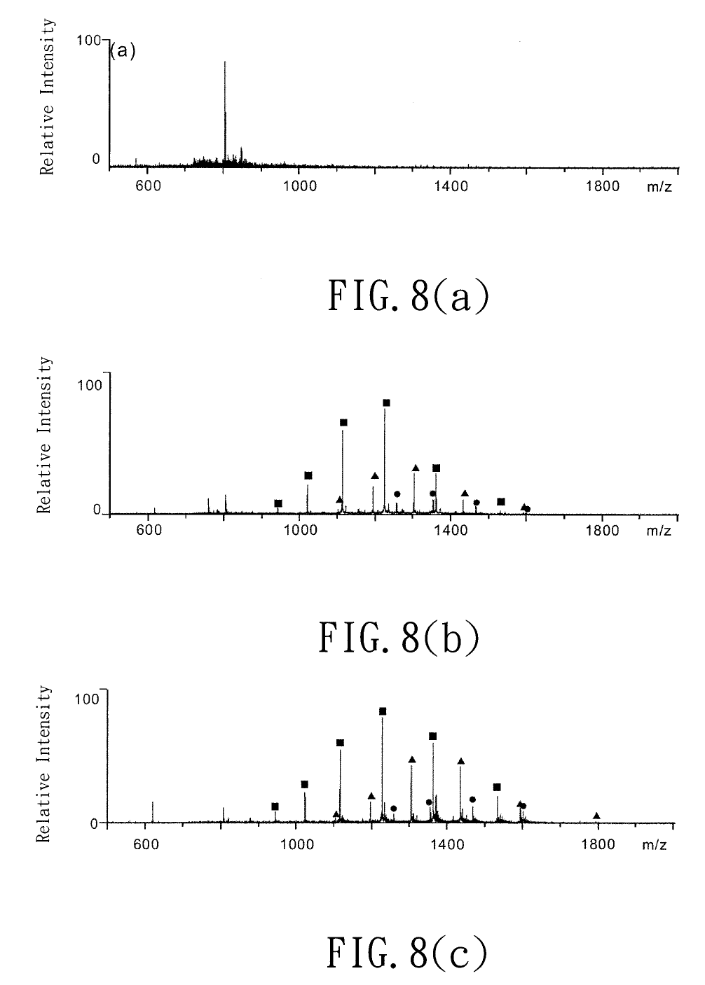

TABLE 1

| | Liquid Sample | | |
|---|---|---|---|
| | | Carbon powder | Mass |
| | Analytes | Concentration | spectrum |
| Comparative | myoglobin | 0 mg/μL | FIG. 8(a) |
| example 1 | (10⁻⁵ M), | | |
| Exemplary | cytochrome c | 0.4 mg/μL | FIG. 8(b) |
| Method 1 | (10⁻⁵ M), | | |
| Exemplary | lysozyme | 0.8 mg/μL | FIG. 8(c) |
| Method 2 | (10⁻⁵ M) | | |

Since the electrospray medium used does not contain any acid, the applicant predicted that the mass spectra obtained should present the formation of “un-denatured proteins”. In other words, the molecular weight of myoglobin resulted from exemplary methods 1 and 2, where ALMS analysis was used, should be 17567 Da, instead of 16951 Da, which is the molecular weight of a denatured protein short of one heme molecular (molecular weight of 616 Da) Results

It is clearly shown in FIG. 8(b) and FIG. 8(c) that there are three ion peaks, which are respectively denoted by “▪”, “▴”, “”, and whose molecular weights are calculated by a computer software to be 12232 Da, 14306 Da, and 17567 Da, respectively. The calculated molecular weights almost completely correspond to the molecular weights of myoglobin, cytochrome c, and lysozyme as provided by the manufacturer. In addition, it is obvious that the detected myoglobin is in an un-denatured state. The results confirm that the method of ambient liquid mass spectrometry works effectively, and is capable of conducting direct detection on a liquid sample including a protein so as to obtain accurate and satisfactory quantitative results.

The reason for this success is that, upon irradiation, laser energy of the ultraviolet laser beam is passed on to at least one of the analytes (proteins) contained in the solution of the liquid sample via the matrix material (carbon powders) so that the analyte is successfully desorbed. On the other hand, the liquid sample used in comparative example 1 does not contain carbon powders or any other materials to serve as a matrix, the analytes could not be effectively desorbed from the liquid sample (or the volume of desorbed analytes was too small). Since no or a minimal number of analytes reached and was detected by the mass analyzer for mass spectrometric analysis, corresponding signals for the analytes could not be generated.

It should be noted herein that the peak shown in FIG. 8(a) is an interference signal, and is relatively enlarged due to the absence of analyte signals.

### Exemplary Methods 3 to 6—ALMS Analysis Conducted on Liquid Samples Provided with Different Matrix Materials

In exemplary methods 3 to 6, different materials were used to serve as the matrix for assisting in the desorption of analytes. Among these different materials, 2,5-dihydroxybenzoic acid (2,5-DHB), 3,5-dimethoxy-4-hydroxycinnamic acid (SA), and α-cyano-4-hydroxycinnamic acid (α-CHC) are water soluble. In addition, for exemplary methods 4 to 6, ALMS analysis was conducted when the liquid samples were under two different states. The liquid sample is under a first state when the matrix material is dissolved in the solution of the liquid sample. The liquid sample is under a second state when the matrix material precipitates due to saturation as the concentration of the matrix material gradually increases resulting from gradual evaporation of the solvent in the solution. The composition of the liquid sample used, and the figure number of corresponding mass spectrum for each of the exemplary methods 3 to 6 are tabulated in Table 2 below. Note that the addition of the matrix material used in exemplary methods 4 to 6 was performed by first dissolving 2 mg of the corresponding matrix material in a 1 ml, 70 vol % ACN aqueous solution so as to form a matrix solution, followed by mixing the clear portion of the matrix solution with a pre-prepared myoglobin solution (with concentration of 10⁻⁴ M) at a 1:1 volume ratio so as to form the liquid sample.

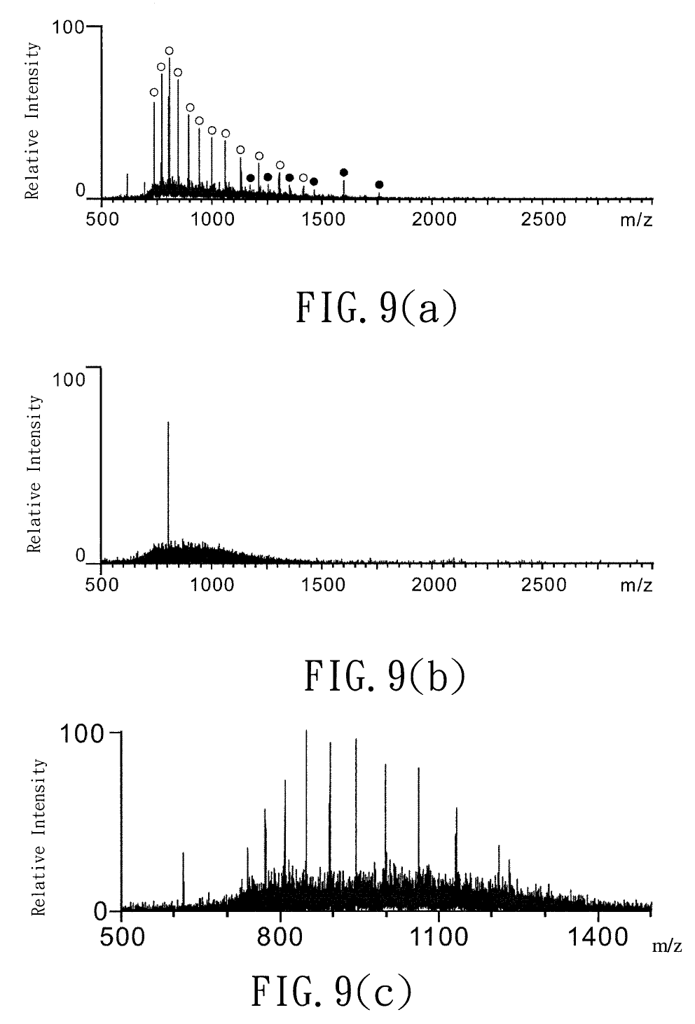

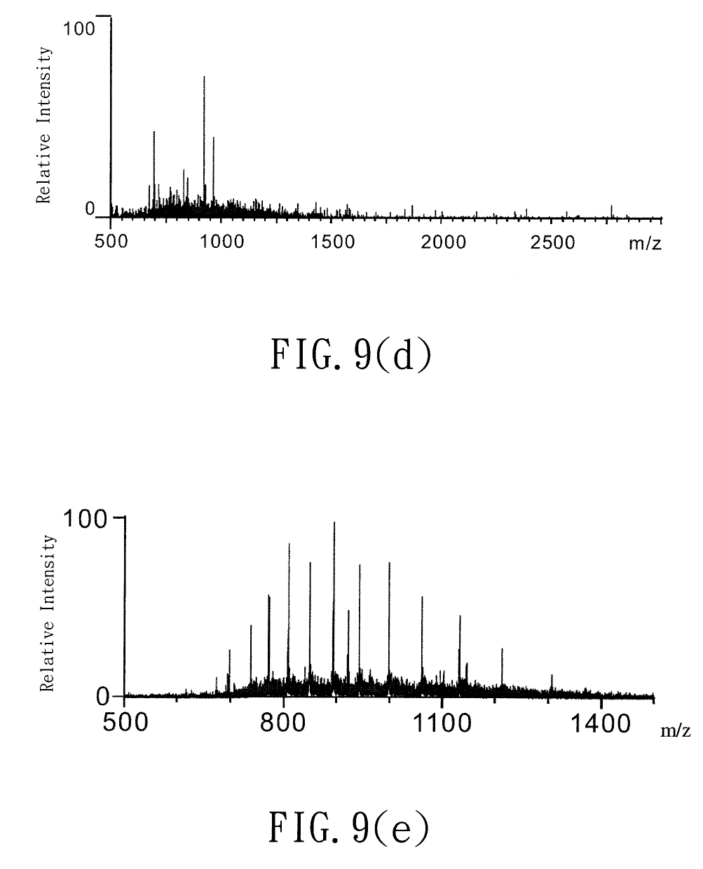

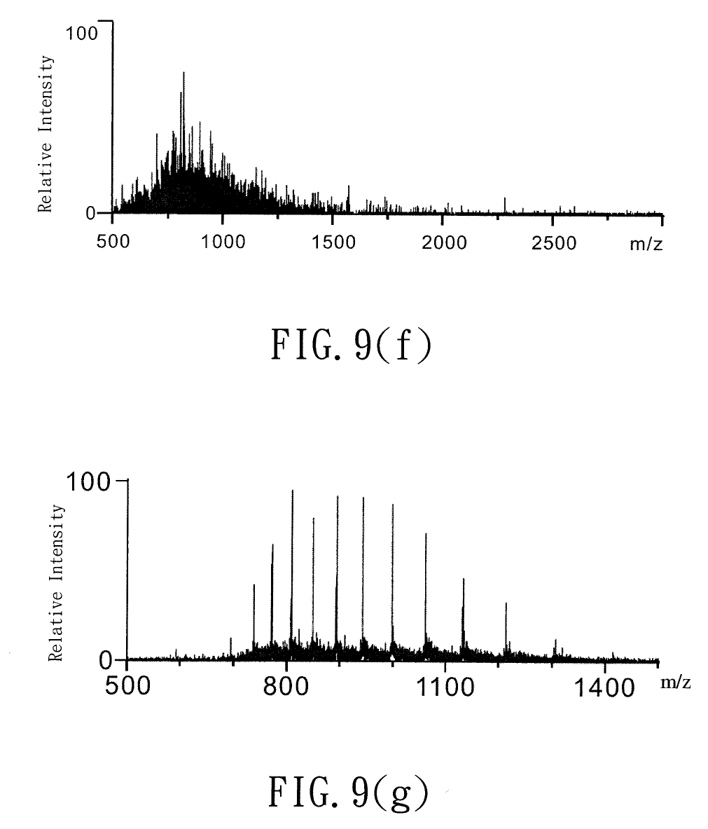

TABLE 2

| | Liquid Sample | | | |
|---|---|---|---|---|
| | | Material | | |
| | | serving as | | |
| | Analytes | Matrix | Mass Spectrum | |
| Exemplary | myoglobin | Gold | FIG. 9(a) | |
| Method 3 | (5 * 10⁻⁵ M), | nano-particles | | |
| Exemplary | | 2,5-DHB | First | FIG. 9(b) |
| Method 4 | | | State | |
| | | | Second | FIG. 9(c) |
| | | | State | |
| Exemplary | | SA | First | FIG. 9(d) |
| Method 5 | | | State | |
| | | | Second | FIG. 9(e) |
| | | | State | |
| Exemplary | | α-CHC | First | FIG. 9(f) |
| Method 6 | | | State | |
| | | | Second | FIG. 9(g) |
| | | | State | |

### Results

FIG. 9(a) clearly indicates the ion peaks formed by the analytes (both un-denatured and denatured myoglobin), where “” denotes the ion peaks formed by the un-denatured myoglobin and “◯” denotes the ion peaks formed by the denatured myoglobin. However, in exemplary methods 4 to 6, when ALMS analysis was conducted while the liquid samples were under the first state, with results respectively shown in FIG. 9(b), FIG. 9(d), and FIG. 9(f), interference formed by the liquid sample is the only thing observed, while no ion peaks formed by myoglobin is observed. On the other hand, in exemplary methods 4 to 6, when ALMS analysis was conducted while the liquid samples were under the second state, with results respectively shown in FIG. 9(c), FIG. 9(e), and FIG. 9(g), ion peaks formed by denatured myoglobin are observed, and molecular weights obtained in these exemplary methods are very close to each other.

In addition, in FIG. 9(c), FIG. 9(e), and FIG. 9(g), an ion peak corresponding to un-denatured myoglobin and having an m/z value greater than 1400 is not observed. The applicant speculates that the reason for this is that since the matrix materials used, i.e., 2,5-DHB, SA, and α-CHC, are organic acids, myoglobin in the liquid samples used in exemplary methods 4 to 6 were all denatured. Consequently, an ion peak corresponding to un-denatured myoglobin is not displayed in each of FIG. 9(c), FIG. 9(e), and FIG. 9(g).

It is illustrated from the above that, other than carbon powders, materials such as gold nano-particles, 2,5-DHB, SA, and α-CHC, etc., can also serve as the matrix material in ALMS analysis. However, it is possible for the materials to be required to have particle diameters greater than a specific value in order to be able to assist in the desorption of the analytes so as to proceed with subsequent mass spectrometric analysis.

### Exemplary Methods 7 to 12—ALMS Analysis Conducted on Liquid Samples Provided with Organic Solutions and Carbon Powders

The composition of the liquid sample used, and the figure number of corresponding mass spectrum for each of the exemplary methods 7 to 12 are tabulated in Table 3 below.

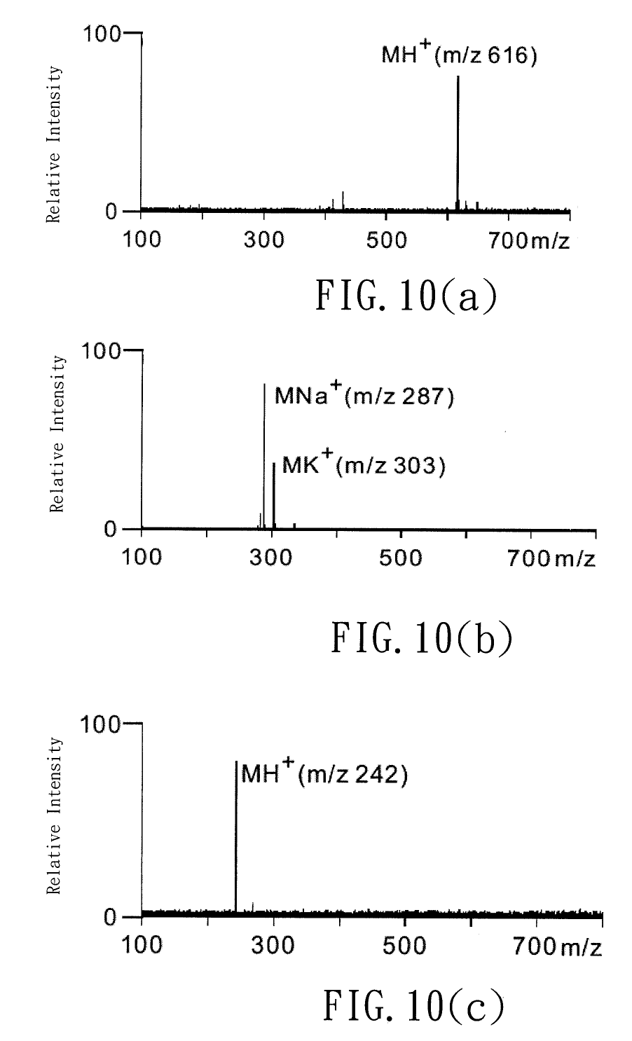

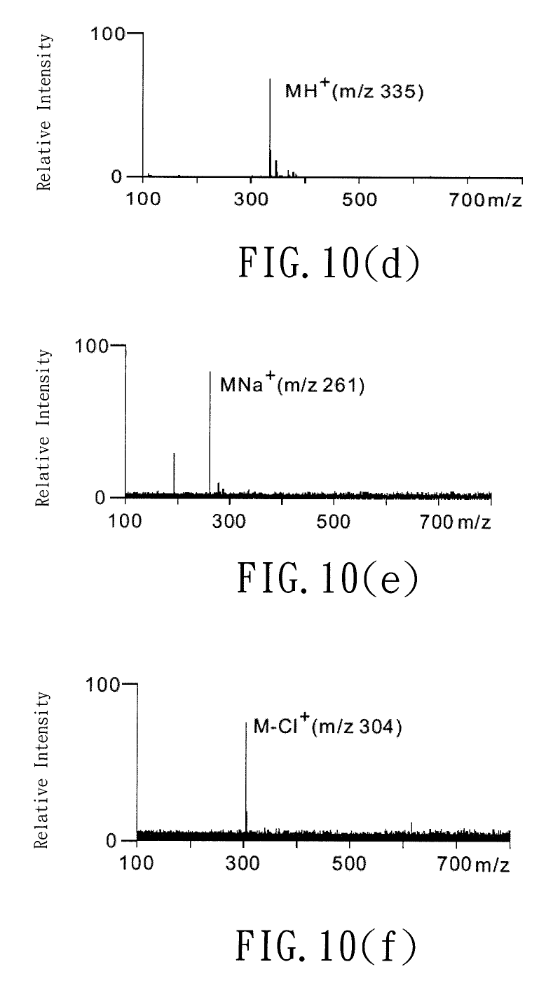

TABLE 3

| | Liquid Sample | | | |
|---|---|---|---|---|
| | Material | | | |
| | serving | | Analytes and | |
| | as | | Concentration | Mass |
| | Matrix | Solvent | thereof | Spectrum |
| Exemplary | Carbon | Methanol | Hemin (2 * 10⁻³M) | FIG. 10(a) |
| Method 7 | powder | | | |
| Exemplary | (0.8 mg/μL) | THF | 18-crown-6-ether | FIG. 10(b) |
| Method 8 | | | (2 * 10⁻²M) | |
| Exemplary | | EA | 1-hexadecylamine | FIG. 10(c) |
| Method 9 | | | (1 * 10⁻³M) | |
| Exemplary | | Methylene | Methyl (triphenyl- | FIG. 10(d) |
| Method 10 | | dichloride | phosphoranylidene) | |
| | | | acetate | |
| | | | (1 * 10⁻²M) | |
| Exemplary | | Tolene | Cinnamic acid | FIG. 10(e) |
| Method 11 | | | benzyl ester | |
| | | | (2 * 10⁻²M) | |
| Exemplary | | n-hexane | Cetylpyridinium | FIG. 10(f) |
| Method 12 | | | chloride | |
| | | | (1 * 10⁻⁴M) | |

### Results

It is clearly observed in FIGS. 10(a) to 10(f) corresponding ion peaks formed by analytes of the liquid samples used in exemplary methods 7 to 12. In addition, the molecular weights obtained after calculation match with the known facts, confirming the operability of the method of ambient liquid mass spectrometry on liquid samples provided with organic solutions and organic compounds.

### Exemplary Method 13 and Comparative Examples 2 and 3—Comparison between Analysis Results on Protein Standard Samples Obtained Using ALMS Analysis, ESI-MS Analysis and MALDI-MS Analysis

In exemplary method 13 and comparative examples 2 and 3, identical analytes (protein standards including insulin, cytochromec, lysozyme, and myoglobin) were used, and were respectively prepared into suitable liquid samples for mass spectrometric analysis using ALMS, ESI-MS and MALDI-MS methods. The composition of the liquid samples used, and the figure number of corresponding mass spectrum for each of exemplary method 13 and comparative examples 2 and 3 are tabulated in Table 4 below. Here, the liquid samples include aqueous solutions. The preparation method for the sample used in comparative example 3, where MALDI-MS method was used, was by first mixing a saturated aqueous solution of the matrix material and a solution containing the analytes with a 1:1 volume ratio so as to obtain a liquid sample, and then by dehydrating a suitable amount of the liquid sample to obtain a solid sample for conducting the mass spectrometric analysis using MALDI-MS method.

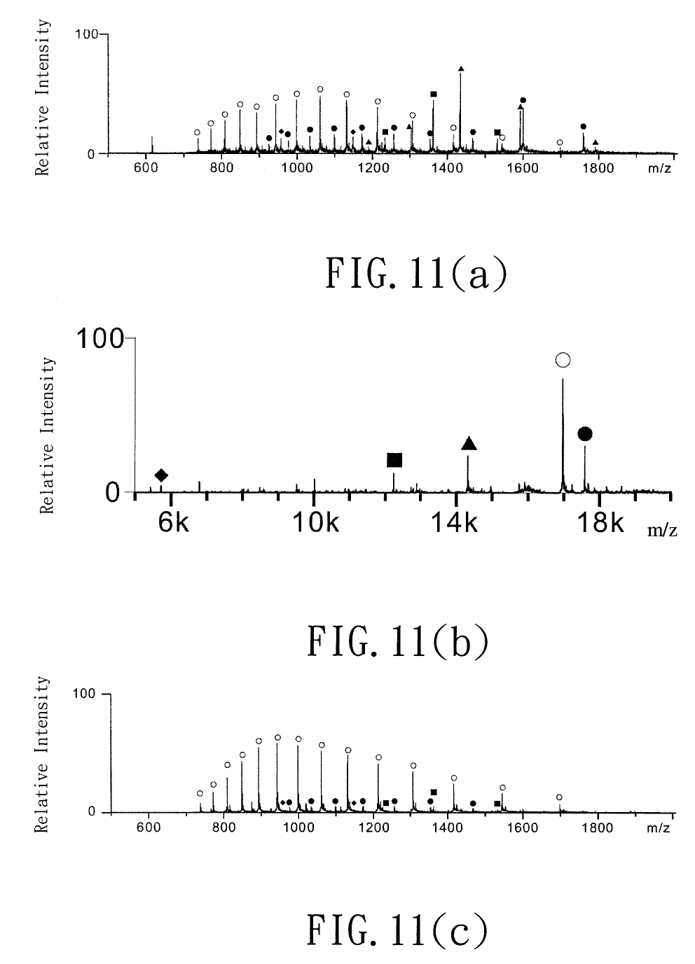

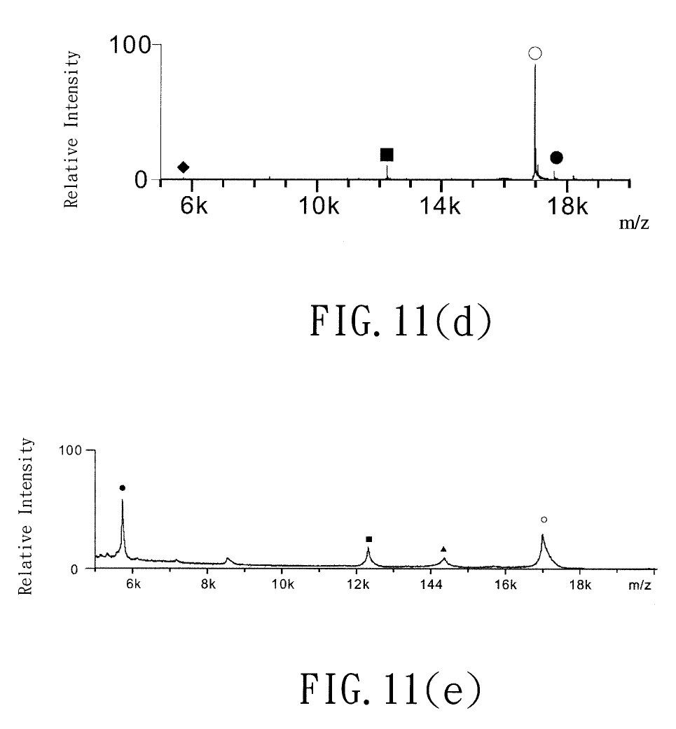

TABLE 4

| | | Liquid Sample | | |
|---|---|---|---|---|
| | | Material | Analytes and | |
| | Method of | Serving as | Concentration | Mass |
| | Analysis | Matrix | thereof | Spectrum |
| Exemplary | ALMS | Carbon | Insulin | FIG. 11(a) |
| Method 13 | | powder | (0.28 * 10⁻⁴M) | FIG. 11(b) |
| | | (0.8 mg/μL) | cytochrome c | |
| Comparative | ESI-MS | — | (0.56 * 10⁻⁴M) | FIG. 11(c) |
| Example 2 | | | lysozyme | FIG. 11(d) |
| Comparative | MALDI-MS | α-CHC | (1.39 * 10⁻⁴M) | FIG. 11(e) |
| Example 3 | | | myoglobin | |
| | | | (2.78 * 10⁻⁴M) | |

### Results

The mass spectrum of FIG. 11(a) shows all of the ion peak groups generated by the different kinds of analytes (i.e., protein standards), where “♦” denotes the ion peaks formed by insulin, “▪” denotes the ion peaks formed by cytochrome c, “▴” denotes the ion peaks formed by lysozyme, “” denotes the ion peaks formed by un-denatured myoglobin, and “◯” denotes the ion peaks formed by denatured myoglobin. In FIG. 11(b), which is a deconvoluted mass spectrum of FIG. 11(a), the ion peaks representing the different kinds of analytes are clearly illustrated using symbols corresponding to those used in FIG. 11(a), where two ion peaks with m/z values of 17567 and 16951 respectively represent un-denatured and denatured myoglobin.

Further, since the proportions of insulin, cytochrome c, lysozyme, and myoglobin in the liquid sample is 1:2:5:10, it can be observed from FIG. 11(b) that relative intensities of the ion peaks generated by insulin, cytochrome c, lysozyme, and myoglobin substantially correspond to their respective proportions in the liquid sample (note that the relative intensity for myoglobin refers to the addition of the relative intensities for the ion peaks with m/z values of 17567 and 16951).

However, an ion peak corresponding to lysozyme, which is denoted by “▴” as in FIG. 11(a), is not shown in FIG. 11(c), where ESI-MS method was used to conduct the mass spectrometric analysis in comparative example 2. In addition, the intensity of the ion peak resulted from insulin is so low that observation thereof is difficult. Even from FIG. 11(d), which is a deconvoluted mass spectrum of FIG. 11(c), the ion peak corresponding to lysozyme is still not clearly observable.

Similarly, in FIG. 11(e), where MALDI-MS method was used to conduct the mass spectrometric analysis, the ion peak corresponding to lysozyme is also not observable. In addition, relative intensities of the rest of the ion peaks in FIG. 11(e) cannot substantially reflect the proportions of insulin, cytochrome c, lysozyme, and myoglobin in the original liquid sample prior to dehydration.

The results illustrate that as opposed to MALDI-MS and ESI-MS, the method of ambient liquid mass spectrometry according to the present invention can rapidly and accurately reflect compositional proportions of the various analytes contained in a liquid sample. Moreover, the method of ambient liquid mass spectrometry further has the potential of “determining the quantities of proteins”. In other words, if, in a liquid samples, there are a particular protein of known concentration and other analytes of unknown concentrations, concentrations of the analytes can be computed through the relative intensities of various ion peaks in a deconvoluted mass spectrum obtained using ALMS analysis.

### Exemplary Methods 14 to 17 and Comparative Examples 4 to 11—Comparison Between Analysis Results on Various Body Fluids Obtained Using ALMS Analysis, ESI-MS Analysis and MALDI-MS Analysis

In exemplary methods 14 to 17 and comparative examples 4 to 11, identical body fluids of various types were used to prepare suitable liquid samples for conducting mass spectrometric analysis using ALMS, ESI-MS and MALDI-MS methods by diluting ten fold with deionized water. For comparative examples 5, 7, 9 and 11, the liquid samples were dehydrated so as to obtain a dehydrated solid sample for mass spectrometric analysis using MALDI-MS method.

The composition of the liquid samples used, and the figure number of corresponding mass spectrum for each of exemplary methods 14 to 17 and comparative examples 4 to 11 are tabulated in Table 5 below. The bacterial extraction used in exemplary method 17 and comparative examples 10 and 11 were prepared as follows:

One milliliter of pure water was used to wash cultured bacteria (standard bacteria manufactured by Food Industry Research and Development Institute, R.O.C. (FIRDI), model no. “Escherichia coli—13082”), followed by conducting centrifugation. Subsequently, supernatant liquid was removed, and 500 μl of aqueous solution containing 0.1 g of glass beads, 70 vol % of ACN and 0.25 vol % of TFA was added. Then, sonication was conducted intermittently to damage cell walls of the bacteria through use of a sonication probe, where a 10-second sonication was followed by a 10-second break, and the process was repeated for 20 minutes. Afterwards, centrifugation was conducted once again and supernatant liquid was removed, at which point, preparation of the bacterial extraction was completed.

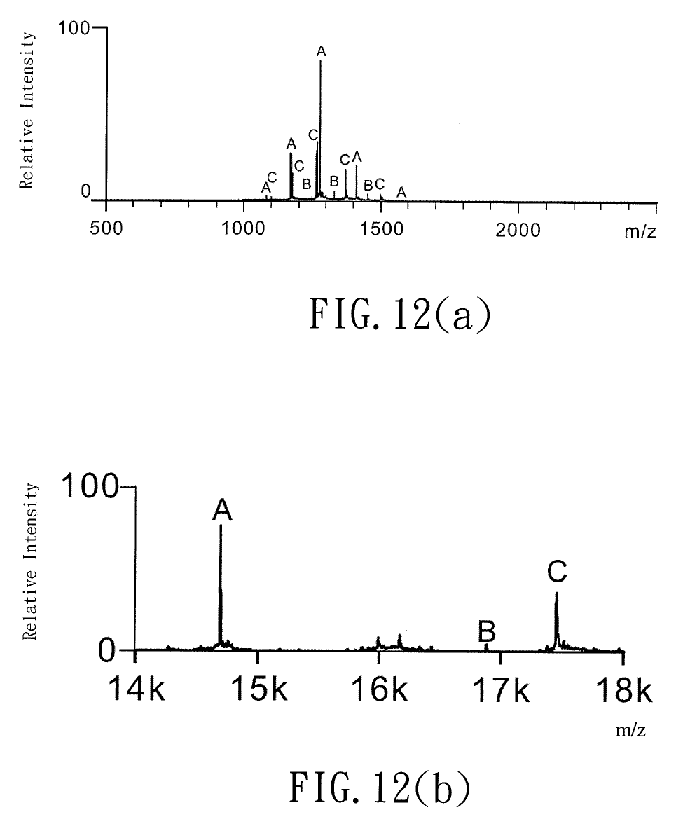

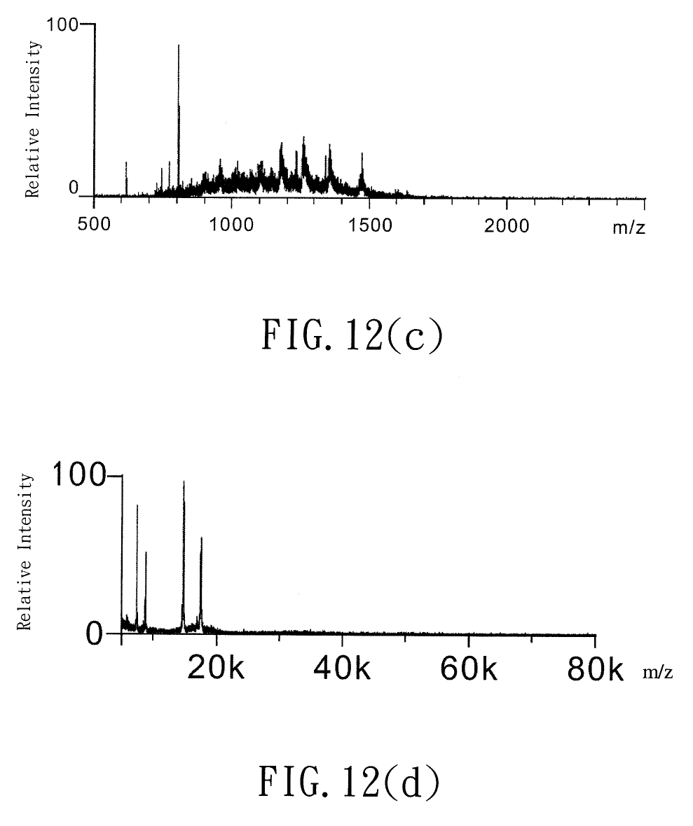

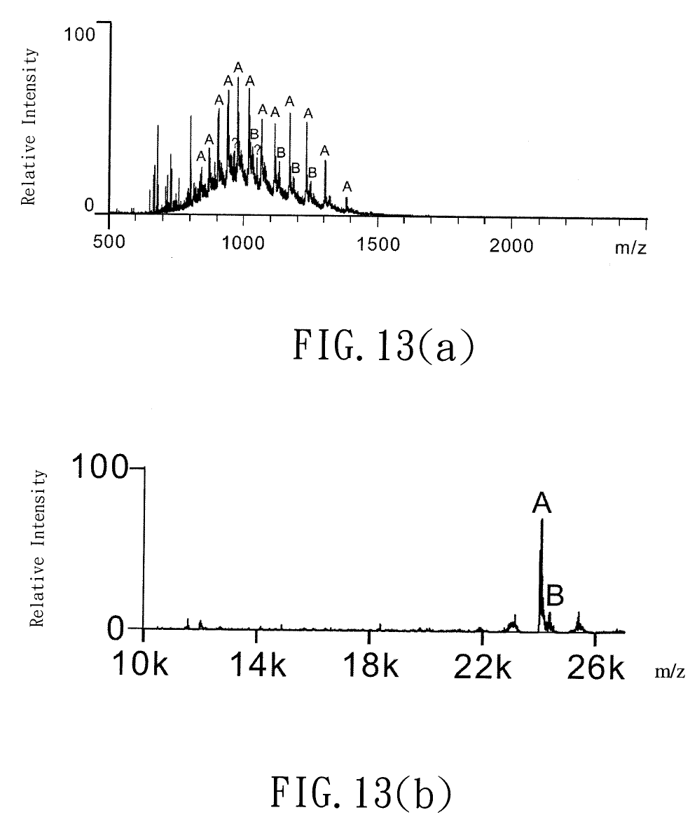

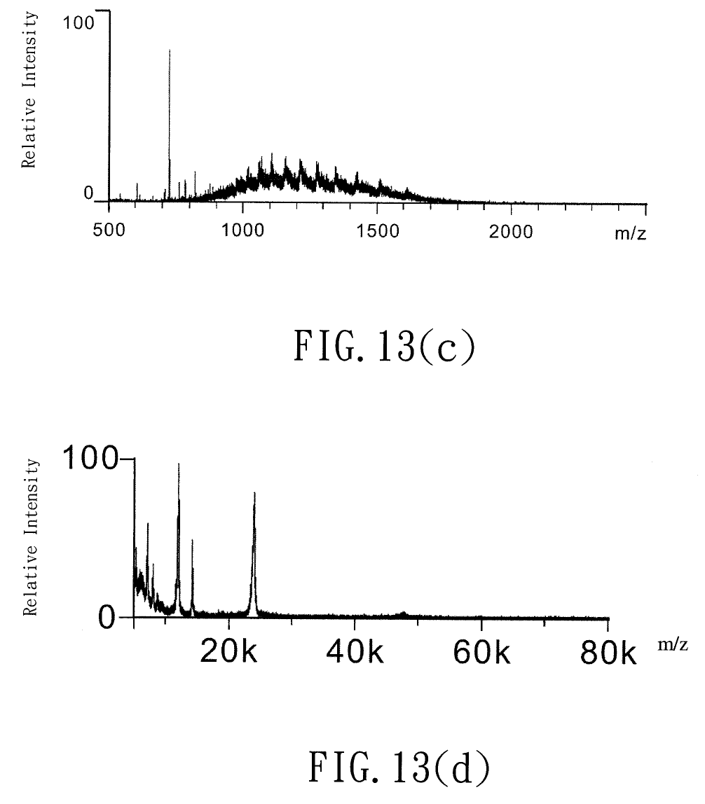

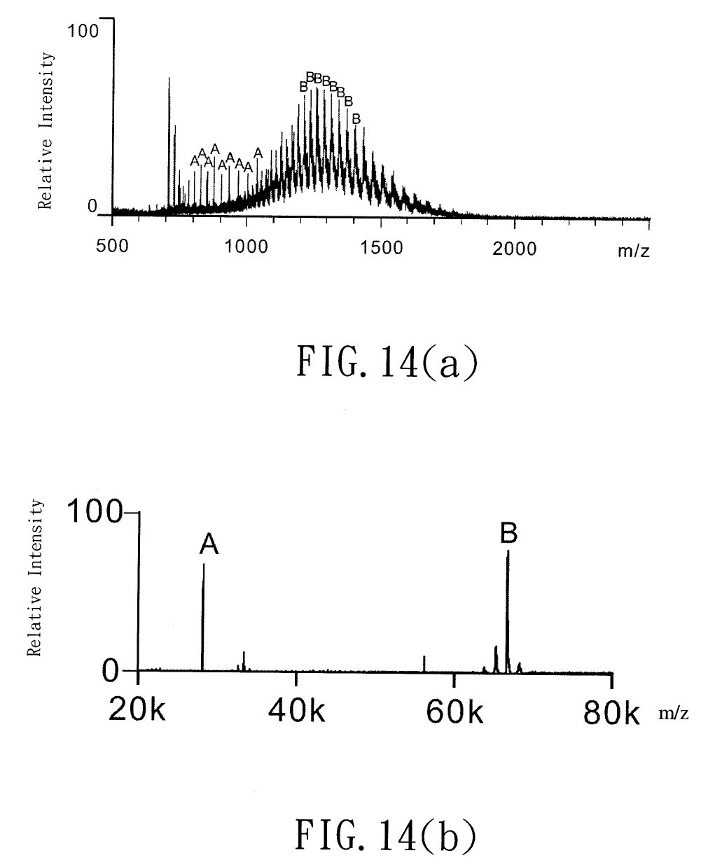

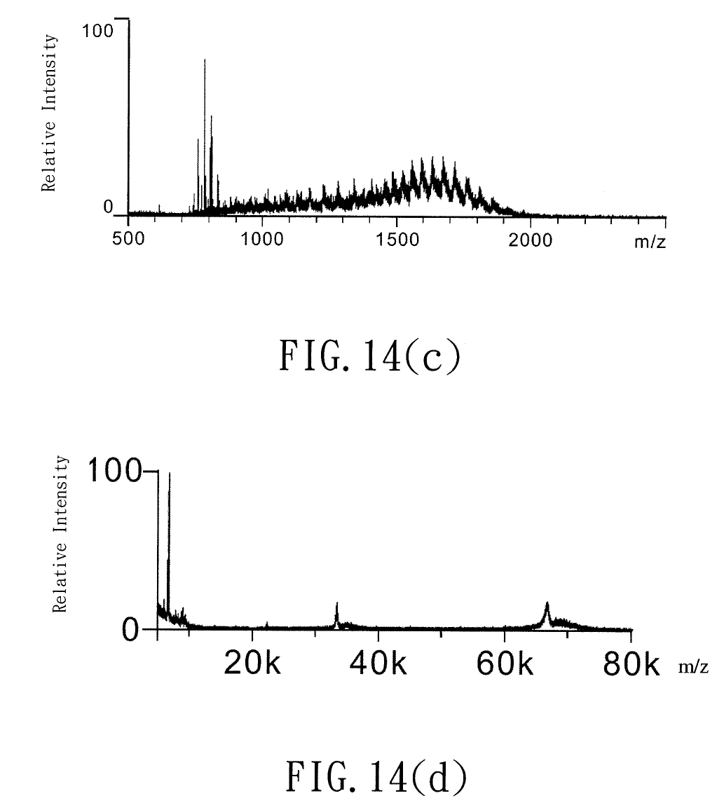

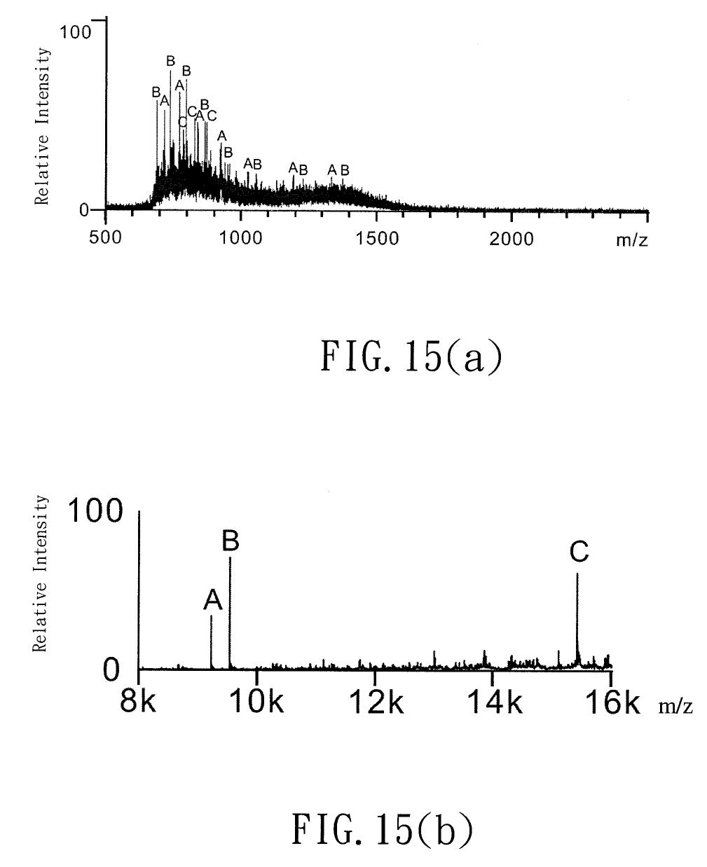

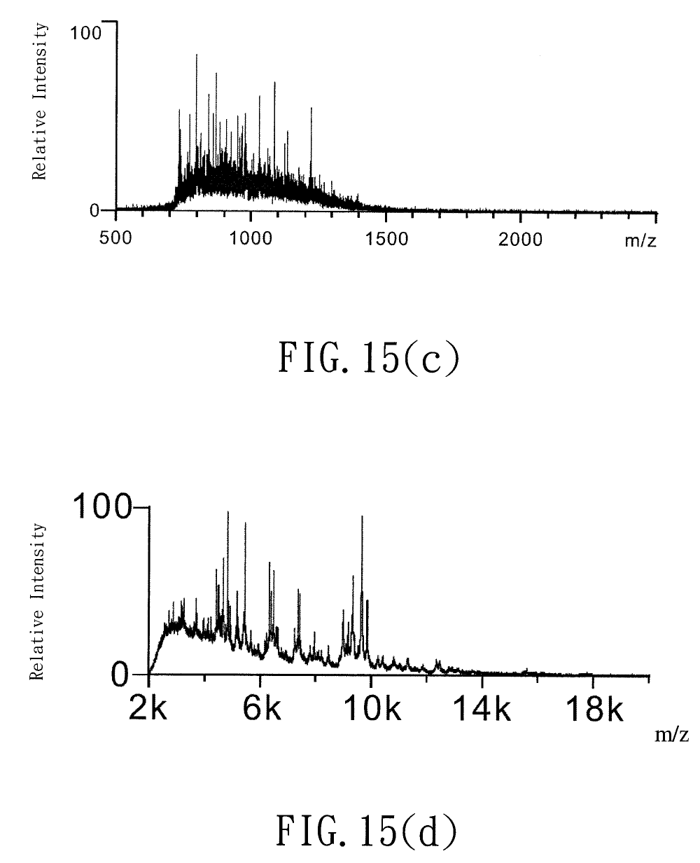

TABLE 5

| | Liquid Sample | | | |
|---|---|---|---|---|
| | | Material | | |
| | | serving | Method | |
| | | as | of | |
| | Body Fluid | Matrix | Analysis | Mass Spectra |
| Exemplary | Human Tear | Carbon | ALMS | FIG. 12(a) |
| Method 14 | | powder | | FIG. 12(b) |
| | | (0.8 mg/μL) | | |
| Comparative | | — | ESI-MS | FIG. 12(c) |
| example 4 | | | | |
| Comparative | | Carbon | MALDI-MS | FIG. 12(d) |
| example 5 | | powder | | |
| | | (0.8 mg/μL) | | |
| Exemplary | Whole Milk | Carbon | ALMS | FIG. 13(a) |
| Method 15 | | powder | | FIG. 13(b) |
| | | (0.8 mg/μL) | | |
| Comparative | | — | ESI-MS | FIG. 13(c) |
| example 6 | | | | |
| Comparative | | Carbon | MALDI-MS | FIG. 13(d) |
| example 7 | | powder | | |
| | | (0.8 mg/μL) | | |
| Exemplary | Blood | Carbon | ALMS | FIG. 14(a) |
| Method 16 | Serum | powder | | FIG. 14(b) |
| | | (0.8 mg/μL) | | |
| Comparative | | — | ESI-MS | FIG. 14(c) |
| example 8 | | | | |
| Comparative | | Carbon | MALDI-MS | FIG. 14(d) |
| example 9 | | powder | | |
| | | (0.8 mg/μL) | | |
| Exemplary | Bacterial | Carbon | ALMS | FIG. 15(a) |
| Method 17 | Extraction | powder | | FIG. 15(b) |
| | | (0.8 mg/μL) | | |
| Comparative | | — | ESI-MS | FIG. 15(c) |
| example 10 | | | | |
| Comparative | | Carbon | MALDI-MS | FIG. 15(d) |
| example 11 | | powder | | |
| | | (0.8 mg/μL) | | |

### Results

As shown in FIG. 12(a) and FIG. 12(b) for exemplary method 14, it is seen that the method of ambient liquid mass spectrometry according to the present invention is successful in detecting three major proteins in human tears, where an ion peak group denoted by “A” is formed by lysozyme, an ion peak group denoted by “C” is formed by tear lipocalin, and an ion peak group denoted by “B” is formed by an unknown protein. As shown in FIG. 13(a) and FIG. 13(b) for exemplary method 15, an ion peak group formed by the major protein in milk, i.e., casin, is observed. It is speculated that the other ion peaks in FIG. 13(a) and FIG. 13(b) are formed by lipid. As shown in FIG. 14(a) and FIG. 14(b) for exemplary method 16, albumin, the major protein in blood serum is observed, where an ion peak denoted by “A” is formed by apolipoprotein A1 (Apo-A1), and an ion peak denoted by “B” is formed by albumin. As shown in FIG. 15(a) and FIG. 15(b) for exemplary method 17, ion peaks formed by three major proteins contained in Escherichia coli are observed.

Furthermore, it is clearly observed from FIGS. 12(a) to 15(d) that, as opposed to conducting mass spectrometric analysis using ESI-MS method (as shown in FIGS. 12(c), 13(c), 14(c), 15(c)) and MALDI-MS method (as shown in FIGS. 12(d), 13(d), 14(d), 15(d)), conducting mass spectrometric analysis using the method of ambient liquid mass spectrometry according to the present invention has a far higher resolution so that accurate molecular weights of the analytes can be obtained after computation.

The reason for this improvement achieved by the method of ambient liquid mass spectrometry as compared with the ESI-MS and MALDI-MS methods is presented hereinbelow as speculated by the applicant. Although the liquid sample contains a large quantity of a variety of salts (present inherently in body fluids), only the analytes are desorbed during the ALMS analysis process, while the salts are not attached to the analytes. In addition, since the cations contained in the electrospray medium only include protons H⁺, all of the ionized analytes received by the mass analyzer are MHₙⁿ⁺ (where “M” denotes the analyte, and “n” represents the number of protons attached to the analyte) such that the resultant mass spectrum has a relatively high resolution.

### Exemplary Method 18—Analyzing Blood of a Diabetes Patient Using ALMS Analysis

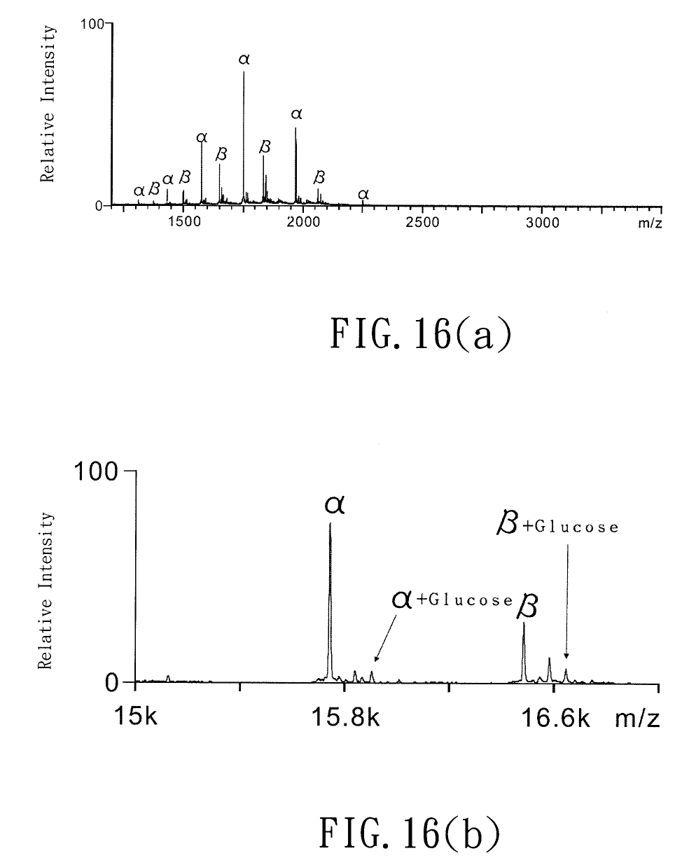

The electrospray medium used in exemplary method 18 is a 20 vol % methanol aqueous solution. The liquid sample was prepared by diluting blood of a diabetes patient (provided privately) ten fold with deionized water, and by adding carbon powders therein such that the concentration of the carbon powders is 0.8 mg/μL. ALMS analysis was conducted on the liquid sample in attempt to detect hemoglobin (Hb) and glycosylated hemoglobin (HbA1) with analysis results shown in FIG. 16(a) and FIG. 16(b), where FIG. 16(b) is a deconvoluted mass spectrum of FIG. 16(a).

Since hemoglobin is composed of α-chain molecules and β-chain molecules non-covalently bound, bonding strength between the α-chain molecules and the β-chain molecules is weak. Glycosylated hemoglobin is formed after the hemoglobin molecules are combined with glucose molecules. As shown in FIG. 16(a), ion peaks formed by the α-chain molecules and the β-chain molecules in hemoglobin are clearly observed, where “α” denotes ion peaks formed by the α-chain molecules in hemoglobin and “β” denotes ion peaks formed by the β-chain molecules in hemoglobin. As shown in FIG. 16(b), the glucose-combined α-chain molecules and the glucose-combined β-chain molecules in glycosylated hemoglobin are clearly observed, where “α+glucose” denotes ion peaks formed by the glucose-combined α-chain molecules in glycosylated hemoglobin and “β+glucose” denotes ion peaks formed by the glucose-combined β-chain molecules in glycosylated hemoglobin.

Further, a ratio between glycosylated hemoglobin and hemoglobin (referred to hereinafter as the (HbA1/Hb) value) is computed with respect to FIG. 16(b). The α-chain molecules and the glucose-combined α-chain molecules are taken to be representative in the computation, where the area covered by the ion peaks formed by the α-chain molecules is given a value (C), and the area covered by the ion peaks formed by the glucose-combined α-chain molecules is given a value (D), and the (HbA1/Hb) value is equal to D/(C+D).

### Exemplary Method 19—Evaluating Credibility of “Analyzing Quantity of Glycosylated Hemoglobin Contained in Blood of A Diabetes Patient Using ALMS Analysis”

ALMS analysis identical to that described in exemplary method 18 was conducted for three times on a blood sample acquired from each of nine diabetes patients, and (HbA1/Hb) values were computed each time ALMS analysis was conducted. Consequently, a total of twenty-seven (HbA1/Hb) values were obtained using ALMS analysis. In addition, each time ALMS analysis was conducted on each blood sample, ionic chromatography (IC, which is a method commonly used in the medial field to detect the quantities of hemoglobin and glycosylated hemoglobin) was also conducted for (HbA1/Hb) value detection and computation. Therefore, with each patient contributing one blood sample, a total of nine average (HbA1/Hb) values was obtained using ionic chromatography.

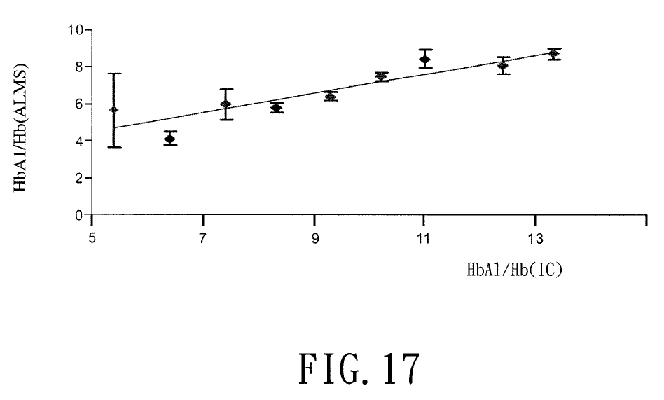

Subsequently, the results are marked in an X-Y coordinate system shown in FIG. 17, where X-axis represents the average (HbA1/Hb) values obtained using ionic chromatography and Y-axis represents the (HbA1/Hb) values obtained using ALMS analysis. There are three points for each patient in the X-Y coordinate system, and an average of these three points is calculated for each patient so that there is a total of nine average points in the X-Y coordinate system. Linear regression analysis was then conducted on these nine average points, and a linear equation is obtained as follows: y=0.5882x+1.1964 with Pearson's coefficient of regression, R², being 0.8666.

### Results

It can be seen from the linear equation obtained through linear regression analysis that the (HbA1/Hb) values obtained using ALMS analysis has a specific relationship with those obtained using ionic chromatography, which is a currently common method used in the medical field for obtaining the quantities of hemoglobin and glycosylated hemoglobin. Therefore, the (HbA1/Hb) values obtained using ALMS analysis should have a certain degree of credibility and reference value. In particular, it is reported that it takes approximately an hour, including preparation work on the samples, to conduct analysis using ionic chromatography. On the other hand, instantaneous detection and result can be obtained using ALMS analysis. Therefore, the method of ambient liquid mass spectrometry should have the potential of replacing the method of ionic chromatography in providing the basis for diagnoses of diseases.

### Exemplary Method 20—Analyzing Blood of a Diabetes Patient Using ALMS Analysis

Exemplary method 20 was conducted using the fifth preferred embodiment of a mass spectrometer assembly implementing the method of ambient liquid mass spectrometry according the present invention, where the electrospray medium used is a 20 vol % methanol aqueous solution.

Since water molecules are highly absorbent to infrared (IR) light, the applicant speculated that the water molecules contained in an aqueous solution might possibly serve as a matrix for transferring the laser energy to the analytes such that the analytes are desorbed and enter the mass analyzer for subsequent mass spectrometric analysis. In other words, in a liquid sample including an aqueous solution, the “water molecules” contained therein serve as the “matrix” for transferring the laser energy to the analytes such that at least one of the analytes is desorbed.

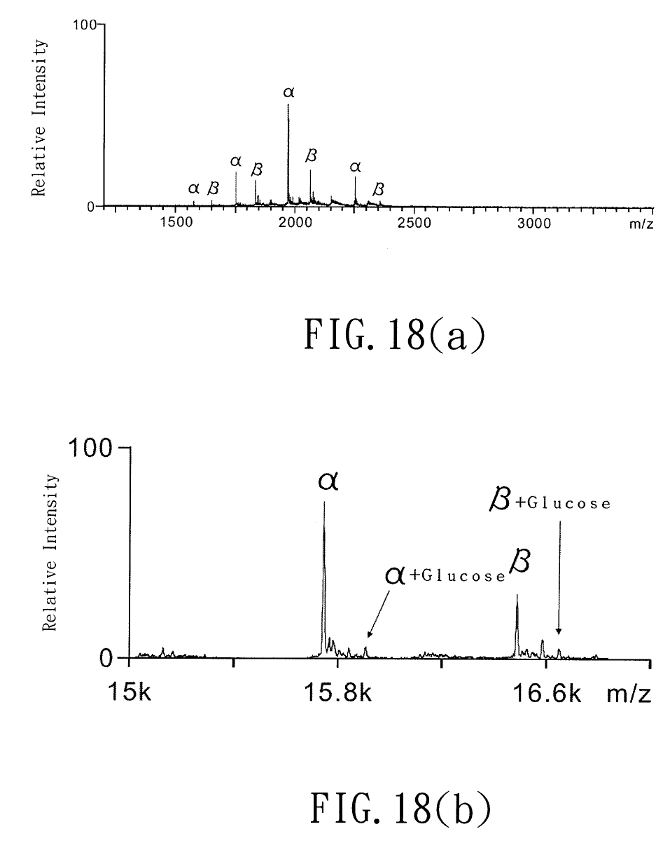

Based on the abovementioned concept, the liquid sample used in this exemplary method is obtained from the blood sample of a diabetes patient identical to that used in exemplary method 18, after diluting ten fold with deionized water, and without adding any additional matrix materials (e.g., those serving as the matrix in previous exemplary methods). ALMS analysis was conducted directly on the liquid sample, and the analysis result obtained is shown in FIG. 18(a) and FIG. 18(b), where FIG. 18(b) is a deconvoluted mass spectrum of FIG. 18(a).

### Results

Ion peak groups are clearly shown in FIG. 18(a) and FIG. 18(b), especially in FIG. 18(b), after simplification. The ion peaks shown in FIG. 18(b) are almost identical to those shown in FIG. 16(b) for exemplary method 18. This result verifies the speculation made by the applicant that when the liquid sample includes an aqueous solution, even if it is a body fluid with complicated composition and containing a large quantity of salts, after a simple diluting step, rapid and convenient analysis can be conducted using the method of ambient liquid mass spectrometry, without adding an additional matrix material, by irradiating an infrared laser beam on the liquid sample, a highly credible mass spectrometric analysis result can be obtained.

With reference to the results described hereinabove with respect to the exemplary methods and comparative examples, it is shown that the present invention is in deed capable of performing rapid and accurate mass spectrometric analysis directly on a liquid sample. In addition, no specific restriction is imposed on the sample to be analyzed, i.e., whether it is a body fluid with a complicated composition, or an organic solution, a protein solution, etc., qualitative information about the contents therein can be obtained through the method of ambient liquid mass spectrometry according to the present invention. Moreover, other than qualitative information, relative quantitative information on various analytes in a liquid sample, such as compositional proportions of the analytes in the liquid sample, can also be reflected through the use of ALMS analysis. It is of special importance that when a liquid sample includes an aqueous solution, by irradiating the liquid sample with infrared laser, satisfactory detection results can be obtained through ALMS analysis.

In addition, a mass spectrometer assembly implementing the method of ambient liquid mass spectrometry should be capable of being connected in series to other analytic instruments. A high performance liquid chromatograph (HPLC) is taken as an example hereinbelow for illustration. When a biochemical sample (normally including an aqueous solution) is eluted after passing through the HPLC, ALMS analysis can be conducted by irradiating laser on the eluted sample when it is disposed between the electrospray unit and the mass analyzer of the mass spectrometer assembly implementing the method of ambient liquid mass spectrometry.

In sum, since the method of ambient liquid mass spectrometry according to the present invention is conducted directly under atmospheric pressure, instead of vacuum, and since operation time needed is extremely short, the cost of instrumentation for implementing the present invention, the technical requirements for manufacturing such instrumentation and for operation of such method have all greatly reduced as compared to matrix-assisted laser desorption ionization mass spectrometry (MALDI-MS) of the prior art. Further, it has been verified that the method of ambient liquid mass spectrometry according to the present invention can be usedto analyze various kinds of liquid samples, including protein aqueous solutions, body fluids, and organic solutions containing organic compounds, etc., can all be analyzed directly (with minimal sample preparation), as opposed to making the originally liquid samples into solid samples. In addition, satisfactory results can be obtained both for qualitative analysis (i.e., the determination of the identity of the analytes detected) and relative quantitative analysis (i.e., the quantity of various kinds of analytes contained in the liquid sample).

Due to the convenience and speed of the method of ambient liquid mass spectrometry according to the present invention, and immediate results obtainable through use of such method, it is evident that the present invention is advantageous in related fields, where qualitative analysis of analytes in a large quantity of liquid samples or determination of relative concentrations of analytes in liquid samples is required, such as in medical fields, environmental examination, criminal judgment, academic research, etc.

The method of ambient liquid mass spectrometry according to the present invention can also be applied to the analysis of a body fluid secreted by an organism. Through identities and relative concentrations of substances in an organism's body fluid, the biological condition of the organism can be determined.

Moreover, the mass spectrometer assembly implementing the method of ambient liquid mass spectrometry according to the present invention can be connected in series to other analytic instruments, such as a high performance liquid chromatograph (HPLC), so that an operator can conduct ALMS analysis so as to obtain information on the substances contained in the sample in sequence with conducting sample purification. This greatly enhances operational convenience and greatly reduces operational time when several analyses need to be conducted on identical samples.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A laser desorption device for use in a mass spectrometer that includes a receiving unit, an electrospray unit, and a voltage supplying member, the receiving unit being disposed to admit therein ionized analytes that are derived from a liquid sample, and that are to be analyzed by the mass spectrometer, the electrospray unit having a nozzle which is configured to sequentially form liquid drops of a liquid electrospray medium thereat, and being spaced apart from the receiving unit in a longitudinal direction so as to define a traveling path, the voltage supplying member being disposed to establish between the electrospray unit and the receiving unit a potential difference which is of an intensity such that the liquid drops are laden with a plurality of charges, and such that the liquid drops are forced to leave the nozzle as multiple-charged ones for heading toward the receiving unit along the traveling path, said laser desorption device comprising:
a sample stage on which the liquid sample is placed, the liquid sample including a solution that contains the analytes and a material serving as a matrix for absorbing laser energy; and
a laser transmission mechanism disposed to irradiate the liquid sample such that, upon irradiation, laser energy is passed on to at least one of the analytes contained in the solution of the liquid sample via the matrix so that said at least one of the analytes is desorbed to fly along a flying path which intersects the traveling path of the multiple-charged liquid drops of the electrospray medium so as to enable said at least one of the analytes to be occluded in the multiple-charged liquid drops, and such that as a result of dwindling in size of the multiple-charged liquid drops when approaching the receiving unit from the nozzle of the electrospray unit along the traveling path, charges of the liquid drops will pass on to said at least one of the analytes occluded therein to form a corresponding one of the ionized analytes.

2. The laser desorption device as claimed in claim 1, wherein the solution is an aqueous solution, the material serving as the matrix being water molecules contained in the aqueous solution, said laser transmission mechanism being an infrared laser.

3. The laser desorption device as claimed in claim 1, wherein the material serving as the matrix is made from a material that is non-transmissible by laser.

4. A mass spectrometer assembly comprising:
a receiving unit disposed to admit therein ionized analytes that are derived from a liquid sample, and including a mass analyzer disposed for analyzing the ionized analytes; and
an electrospray unit including a reservoir for accommodating a liquid electrospray medium, and a nozzle which is disposed downstream of said reservoir, and which is configured to sequentially form a liquid drop of said electrospray medium thereat, said nozzle being spaced apart from said receiving unit in a longitudinal direction so as to define a traveling path;
a voltage supplying member disposed to establish between said nozzle and said receiving unit a potential difference which is of an intensity such that the liquid drop is laden with a plurality of charges, and such that the liquid drop is forced to leave said nozzle as a multiple-charged one for heading toward said receiving unit along the traveling path; and
a laser desorption device including
a sample stage on which the liquid sample is placed, the liquid sample including a solution that contains the analytes and a material serving as a matrix for absorbing laser energy; and
a laser transmission mechanism disposed to irradiate the liquid sample such that, upon irradiation, laser energy is passed on to at least one of the analytes contained in the solution of the liquid sample via the matrix so that said at least one of the analytes is desorbed to fly along a flying path which intersects the traveling path of the multiple-charged liquid drops of said electrospray medium so as to enable said at least one of the analytes to be occluded in said multiple-charged liquid drops, and such that as a result of dwindling in size of the multiple-charged liquid drops when approaching said receiving unit from said nozzle of said electrospray unit along the traveling path, charges of the liquid drops will pass on to said at least one of the analytes occluded therein to form a corresponding one of the ionized analytes.

5. The mass spectrometer assembly as claimed in claim 4, wherein the solution of the liquid sample is an aqueous solution, the material serving as the matrix being water molecules contained in the aqueous solution, said laser transmission mechanism being an infrared laser.

6. The mass spectrometer assembly as claimed in claim 4, wherein said sample stage of said laser desorption device includes a movable track, and a support member having the liquid sample disposed thereon, and mounted movably on said track such that the liquid sample moves with said supporting member along said track.

7. The mass spectrometer assembly as claimed in claim 4, wherein said sample stage of said laser desorption device includes a support member that is made from a material non-transmissible by laser, and that has a support surface for placement of the liquid sample directly thereon.

8. A method for mass spectrometry, comprising the steps of:
placing, on a sample stage, a liquid sample including a solution that contains a plurality of analytes and a material serving as a matrix for absorbing laser energy;
providing an electrospray unit that includes a nozzle configured to sequentially form liquid drops of an electrospray medium thereat;
providing a receiving unit that is disposed to admit therein ionized analytes that are derived from the liquid sample, and that are to be analyzed by a mass analyzer disposed downstream of the receiving unit, the receiving unit being spaced apart from the nozzle of the electrospray unit in a longitudinal direction so as to define a traveling path;
establishing a potential difference between the nozzle of the electrospray unit and the receiving unit, the potential difference being of an intensity such that the liquid drops are laden with a plurality of charges, and such that the liquid drops are forced to leave the nozzle as multiple-charged ones for heading toward the receiving unit along the traveling path; and
irradiating the liquid sample with a laser beam such that, upon irradiation, laser energy is passed on to at least one of the analytes contained in the solution of the liquid sample via the matrix so that said at least one of the analytes contained in the liquid sample is desorbed to fly along a flying path which intersects the traveling path so as to enable said at least one of the analytes to be occluded in the multiple-charged liquid drops, and such that as a result of dwindling in size of the multiple-charged liquid drops when approaching the receiving unit along the traveling path, charges of the liquid drops will pass on to said at least one of the analytes occluded therein to form a corresponding one of the ionized analytes.

9. The method as claimed in claim 8, wherein the solution is an aqueous solution, the material serving as the matrix being water molecules contained in the aqueous solution, the laser beam being infrared laser beam.

10. The method as claimed in claim 8, wherein the material serving as the matrix is made from a material that is non-transmissible by laser.

11. The method as claimed in claim 10, wherein the material serving as the matrix is selected from the group consisting of gold, carbon, cobalt, iron, 2,5-dihydroxybenzoic acid (2,5-DHB), 3,5-dimethoxy-4-hydroxycinnamic acid (SA), α-cyano-4-hydroxycinnamic acid (α-CHC), or a combination thereof.

12. The method as claimed in claim 11, wherein the material serving as the matrix is selected from the group consisting of gold, carbon, 2,5-dihydroxybenzoic acid (2,5-DHB), 3,5-dimethoxy-4-hydroxycinnamic acid (SA), α-cyano-4-hydroxycinnamic acid (α-CHC), or a combination thereof.

13. The method as claimed in claim 8, wherein particle diameter of the material serving as the matrix ranges from 50 nm to 50 μm.

14. The method as claimed in claim 8, wherein the solution included in the liquid sample is a body fluid secreted by an organism.

15. The method as claimed in claim 8, wherein the solution included in the liquid sample is a body fluid secreted by an organism and diluted with water.

16. The method as claimed in claim 15, wherein the body fluid is selected from the group consisting of blood, tear, milk, perspiration, intestinal juice, brains fluid, spinal fluid, lymph, pus, blood serum, saliva, nasal mucus, urine, and excrement.

17. The method as claimed in claim 16, wherein the body fluid is selected from the group consisting of blood, tear, milk, and blood serum.

18. The method as claimed in claim 8, wherein the solution included in the liquid sample is a protein solution.

19. The method as claimed in claim 8, wherein the solution included in the liquid sample includes an organic solvent, and the analytes contained in the solution are organic compounds.

20. The method as claimed in claim 8, wherein the electrospray medium is an aqueous solution containing a volatile liquid.

21. The method as claimed in claim 20, wherein the volatile liquid is selected from the group consisting of isoacetonitrile, acetone, alcohol, or a combination thereof.

22. The method as claimed in claim 21, wherein the volatile liquid is alcohol.

23. The method as claimed in claim 22, wherein the volatile liquid is methanol.

24. The method as claimed in claim 20, wherein the electrospray medium is an aqueous solution further containing an acid.

25. The method as claimed in claim 24, wherein the electrospray medium is an aqueous solution containing alcohol, and an acid that is selected from the group consisting of formic acid, acetic acid, trifluroacetic acid, and a combination thereof.

26. The method as claimed in claim 25, wherein the electrospray medium is an aqueous solution containing methanol and acetic acid.
